(19) United States
(12) Patent Application Publication
(10) Pub. No.: US 2024/0299787 A1
(43) Pub. Date: Sep. 12, 2024

(54) FIRE SUPPRESSION SYSTEM HAVING VALVE STRUCTURE

(71) Applicant: Yong Taek MOON, Yongin-si (KR)

(72) Inventors: YongTaek MOON, Yongin-si (KR); YoungSook LEE, Yongin-si (KR); HeeJung LEE, La Crescenta, CA (US); JongGu LEE, Yongin-si (KR)

(21) Appl. No.: 18/118,063

(22) Filed: Mar. 6, 2023

(51) Int. Cl. A62C 13/64

(52) U.S. Cl. CPC A62C 13/64

(57) ABSTRACT

A valve structure includes a body defining an internal passage and including a discharge hole having a predetermined diameter, and a spray unit arranged to be movable in the internal passage and exposed to an outside through the discharge hole.

### TECHNICAL FIELD

The present disclosure relates to a valve structure and a fire suppression system having the same, and more specifically, to a valve structure, which quickly extinguishes a fire by detecting fire-related environmental conditions and automatically operating a fire extinguisher and a fire suppression system having the same.

### BACKGROUND ART

As construction technology has advanced and high-rise buildings have become common, technologies for preventing or minimizing disasters in these buildings have been developed. The risk of a fire, spreading quickly from one area to another and causing great damages, is particularly high in high-rise buildings where residential and commercial spaces are densely clustered together. For example, a fire on one floor of a residential-commercial building that is not extinguished in its early stage can quickly spread to other parts of the building and cause severe damages. Thus, it is crucial to extinguish a fire as early as possible. If a fire is not extinguished in its early stage and spreads, it becomes more difficult to contain, leading to significant property damages and casualties.

In general, examples of fire suppression system for detecting and extinguishing fires include fire detectors and sprinklers installed on the ceiling or walls of a building, as well as fire extinguishers and fire hydrants placed in various locations of the building. The fire detector serves to warn people of the occurrence of a fire by detecting heat, smoke, and other indicators of a fire using fire detection devices such as a heat detection sensor and a smoke detection sensor, and activating an alarm sound or warning light.

However, conventional fire suppression systems may not be suitable for an unmanned environment. For example, they may not serve as an early warning measure for a fire that occurs in the absence of a person because a person who can check a fire alarm sound or warning light needs to recognize the same to take action for fire suppression.

In addition, a typical fire extinguisher stores the fire extinguishing fluid in its internal storage space, and the user directly presses the handle of the fire extinguisher to spray the fire extinguishing fluid in the storage space in case of fire. The general fire extinguisher requires the user to remove a safety pin, aim the hose at the fire, and directly manipulate the handle to extinguish the fire. Accordingly, the fire extinguisher has to be operated by the user. In addition, the user may be in the process of extinguishing a fire using the fire extinguisher. As described above, the conventional system requires a user to be present on site to operate the fire extinguishing equipment and take appropriate action for the fire in the early stage.

### PRIOR ART LITERATURE

### Patent Document

(Patent Document 0001) Korean Utility Model No. 20-0447990

### DISCLOSURE

### Technical Problem

Therefore, the present disclosure has been made in view of the above problems, and it is an object of the present disclosure to provide a fire suppression system for quickly extinguishing a fire by automatically operating a fire extinguisher upon detecting a fire-related environmental condition.

It will be appreciated by those skilled in the art that the objects that could be achieved with the present disclosure are not limited to what has been described hereinabove and the above and other objects that the present disclosure could achieve will be more clearly understood from the following detailed description.

### Technical Solution

In accordance with the present disclosure, the above and other objects can be accomplished by the provision of a valve structure according to various embodiments of the present disclosure. The valve structure may include a body defining an internal passage and including a discharge hole having a predetermined diameter, and a spray unit movably arranged in the internal passage to be exposed to an outside through the discharge hole.

In an alternative embodiment, the spray unit may be exposed to the outside through the discharge hole in response to a pressure applied to an inside of the body.

In an alternative embodiment, the body may include an inwardly protruding step which protrudes inwardly, and a lower passage provided on a lower side of the inwardly protruding step.

In an alternative embodiment, the spray unit may include a head having a diameter corresponding to an inner diameter of the internal passage and configured to perform a vertical movement in response to a pressure applied to an inside of the body, a lengthwise part extending in one direction from the head and having a plurality of perforations, a center hole formed inside the head and the lengthwise part along a longitudinal direction and connected to the plurality of perforations, and a spray protrusion provided at one end of the lengthwise part that is opposite the head, wherein at least a portion of the lengthwise part may protrude to the outside of the body when a pressure is applied to the internal passage.

In an alternative embodiment, the spray protrusion may be extended by the pressure applied to the center hole, wherein, when the spray protrusion is extended, the spray protrusion may form a passage for discharging the fire extinguishing agent through a gap between the center hole and the spray protrusion.

In an alternative embodiment, the spray protrusion may include a spray protrusion support step arranged to contact a protrusion support surface formed in the center hole when extended by the pressure applied to the lengthwise part, and a spray surface positioned above an upper side of the spray protrusion support step and having a step shape protruding along an outer circumferential surface.

In an alternative embodiment, the valve structure may further include a control valve provided in the lower passage to be at least partially movable into the internal passage by a pressure, the control valve being configured to control introduction of a fire extinguishing agent into the internal passage.

In an alternative embodiment, the control valve may include a control valve head configured to perform a vertical movement in response to a pressure applied thereto, a control valve lengthwise part extending from the control valve head in one direction and having a plurality of agent discharge holes, a control valve center hole formed inside the control valve head and the control valve lengthwise part in a longitudinal direction and connected to the plurality of agent discharge holes, and a spring having one end connected to one surface of the control valve head and the other end connected to an inner portion of the body to control a vertical movement of the control valve head.

In another embodiment of the present disclosure, a fire suppression system is provided. The fire suppression system may include a fire extinguishing unit equipped with the valve structure and configured to discharge the fire extinguishing agent to the outside, a sensor unit configured to sense fire environmental information, and a controller configured to control an operation of the fire extinguishing unit based on the environment information.

In an alternative embodiment, the fire extinguishing unit may include a fire extinguishing cylinder configured to deliver the fire extinguishing agent to the valve structure, and a gas supply unit containing the fire extinguishing agent therein and configured to supply the fire extinguishing agent to the fire extinguishing cylinder.

Other specific details of the disclosure are included in the detailed description and drawings.

### Advantageous Effects

According to various embodiments of the present disclosure, a fire suppression system for quickly extinguishing a fire by automatically operating a fire extinguisher upon detecting fire-related environmental conditions may be provided. Fire suppression may be automatically performed without user manipulation, thereby preventing further damages through initial fire suppression and reducing the possibility of personal injury. In other words, the present invention improves convenience and safety in fire suppression in the event of a fire.

It will be appreciated by those skilled in the art that the effects that can be achieved with the present disclosure are not limited to what has been particularly described hereinabove and other advantages of the various embodiments will be more clearly understood from the following detailed description.

### BRIEF DESCRIPTION OF DRAWINGS

Numbers are used to collectively refer to similar elements. In the following embodiments, for explanation purposes, numerous specific details are set forth in order to provide a thorough understanding of one or more aspects. However, it will become apparent that such aspect (s) may be practiced without such specific details.

FIG. 1 is a block diagram of a fire suppression system according to an embodiment of the present disclosure.

FIG. 2 is an exemplary view illustrating an assembly of a fire extinguishing unit according to an embodiment of the present disclosure.

FIG. 3 is an exploded view showing a valve structure according to an embodiment of the present disclosure.

FIG. 4 is an exemplary view illustrating a spray unit according to an embodiment of the present disclosure.

FIG. 5 is an exemplary view illustrating an operation of discharging a fire extinguishing agent to the outside according to an embodiment of the present disclosure.

FIG. 6 is an exemplary view illustrating a y-shaped fire extinguishing cylinder according to another embodiment of the present disclosure.

FIG. 7 is an exemplary view illustrating coupling of a fire extinguishing cylinder and a gas supply unit according to an embodiment of the present disclosure.

FIG. 8 is an exemplary view illustrating an overall assembly of a fire extinguishing unit according to another embodiment of the present disclosure.

FIG. 9 is an exploded view illustrating a valve structure according to another embodiment of the present disclosure.

FIG. 10 is an exemplary view illustrating a spray unit according to another embodiment of the present disclosure.

FIG. 11 is an exploded view illustrating a bearing and a body according to another embodiment of the present disclosure.

FIG. 12 is an exemplary view illustrating a body and an opening/closing part according to another embodiment of the present disclosure.

FIG. 13 illustrates an exemplary view illustrating an operation of discharging a fire extinguishing agent to the outside through opening and closing according to another embodiment of the present disclosure.

FIG. 14 is an exemplary view illustrating a spring portion and a dust layer according to another embodiment of the present disclosure.

### DETAILED DESCRIPTION OF THE INVENTION

Various embodiments and/or aspects are now disclosed with reference to the drawings. In the following description, for purposes of explanation, numerous specific details are set forth in order to facilitate a general understanding of one or more aspects. However, it will be appreciated by those skilled in the art that such aspect(s) may be practiced without these specific details. The following description and accompanying drawings set forth in detail specific illustrative aspects of one or more aspects.

However, these aspects are exemplary and some of the various methods in the principles of the various aspects may be used, and the descriptions are intended to include all such aspects and their equivalents. Specifically, as used herein, the terms “embodiment,” “example,” “aspect,” “exemplary,” and the like may not be interpreted as meaning that any aspect or a design is better or advantageous than other aspects or designs.

Hereinafter, the same reference numerals are assigned to the same or similar elements regardless of reference numerals, and redundant descriptions thereof are omitted. In addition, in describing the embodiments disclosed in the present disclosure, a detailed description of related known technologies will be omitted to avoid obscuring the gist of the embodiments disclosed in the present disclosure. The accompanying drawings are intended to facilitate understanding of the embodiments disclosed herein, and the spirit and scope of the present disclosure are not limited by the accompanying drawings.

It will be understood that, although the terms “first,” “second,” etc. may be used herein to describe various elements or components, the elements or components should not be limited by these terms.

These terms are only used to distinguish one element or component from another. Therefore, it would be apparent that the first element or component mentioned below may be the second element or component within the technical spirit of the present disclosure.

Unless otherwise defined, all terms (including technical and scientific terms) used herein have the same meaning as commonly understood by one of ordinary skill in the art to which this present disclosure pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Additionally, the term “or” is intended to mean an inclusive “or” rather than an exclusive or”. That is, unless otherwise specified or clear from the context, “X uses A or B” is intended to mean one of the natural inclusive substitutions. That is, if X uses A; X uses B; or X uses both A and B, “X uses A or B” may apply to either of these cases. Also, as used herein, the term “and/or” should be understood to refer to and include all possible combinations of one or more of the listed related items.

Also, the terms “comprises” and/or “comprising” mean that the feature and/or element is present, but should not be understood as excluding the presence or addition of one or more other features, elements and/or groups thereof. Also, unless otherwise specified or unless the context clearly indicates that a singular form is indicated, the singular expression in the present disclosure and claims shall generally be construed to mean “one or more.”

It will be understood that when an element is referred to as being “on”, “connected to” or “coupled to” another element, it may be directly on, connected or coupled to the other element, or intervening elements may be present. In contrast, when an element is referred to as being “directly on,” “directly connected to” or “directly coupled to” another element or layer, there are no intervening elements present.

As used herein, the suffixes “module” and “unit” are added or used interchangeably to facilitate preparation of this specification and are not intended to suggest distinct meanings or functions.

Stating that an element or layer is arranged “on” another element or layer includes arrangement directly on the other element or layer, as well as intervening of other layers or layers between the elements or layers. On the other hand, when an element is referred to as “directly on,” it indicates that no other element or layer is intervening.

The spatially relative terms “below,” “beneath,” “lower,” “above,” “upper,” and the like may be used to easily describe one component or its correlation with other components shown in the figures. The spatially relative terms should be understood as encompassing different orientations of elements in use or operation in addition to the orientations shown in the figures.

For example, when a component shown in a drawing is reversed, the component described as being arranged “below” or “beneath” another component may be placed “above” the other component. Thus, the exemplary term “below” may include directions of both below and above. Components may also be oriented in other directions, and thus the spatially relative terms may be interpreted according to the orientation.

Objects and effects of the present disclosure, and technical configurations for achieving them will become apparent to those having ordinary skill in the art from the embodiments described in detail below in conjunction with the accompanying drawings. In describing the present disclosure, a detailed description of a known function or configuration may be omitted to avoid obscuring the gist of the present disclosure. In addition, the terms described below are defined in consideration of functions in the present disclosure, which may vary according to the intention of a user or operator or the custom.

However, the present disclosure is not limited to the embodiments disclosed below and may be implemented in various different forms. It should be understood that these embodiments are provided such that the disclosure will be thorough and complete, and will fully convey the scope of the disclosure to those skilled in the art. The scope of the disclosure is only defined by the claims. Therefore, the definition should be made based on the contents throughout the present disclosure.

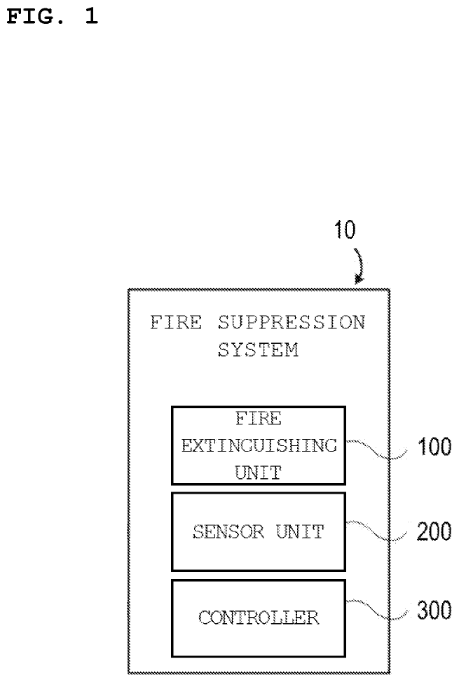

FIG. 1 is a block diagram of a fire suppression system according to an embodiment of the present disclosure. As shown in FIG. 1, the fire suppression system 10 of the present disclosure may include a fire extinguishing unit 100, a sensor unit 200 and a controller 300.

The components shown in FIG. 1 are exemplary. Additional components may be provided or some of the components shown in FIG. 1 may be omitted.

According to an embodiment of the present disclosure, the fire extinguishing unit 100, the sensor unit 200, and the controller 300 included in the fire suppression system 10 may transmit and receive information through interconnection over a network.

The network according to embodiments of the present disclosure may employ various wired communication systems such as Public Switched Telephone Network (PSTN), x Digital Subscriber Line (xDSL), Rate Adaptive DSL (RADSL), Multi Rate DSL (MDSL), Very High Speed DSL (VDSL), Universal Asymmetric DSL (UADSL), High Bit Rate DSL (HDSL), and local area network (LAN).

In addition, the network disclosed herein may employ various wireless communication systems such as Code Division Multi Access (CDMA), Time Division Multi Access (TDMA), Frequency Division Multi Access (FDMA), Orthogonal Frequency Division Multi Access (OFDMA), Single Carrier-FDMA (SC-FDMA), and other systems. The network according to the embodiments of the present disclosure may be configured in any communication modes including a wired mode and a wireless mode, and may be composed of various communication networks such as a personal area network (PAN) and a wide area network (WAN). In addition, the network may be the known World Wide Web (WWW), or may employ a wireless transmission technology used for short-range communication, such as Infrared Data Association (IrDA) or Bluetooth. The technologies described herein may be used for other networks as well as the networks mentioned above.

According to an embodiment of the present disclosure, the fire suppression system 10 may sense or detect information related to changes in fire environmental information to determine whether a fire has occurred. When it is determined that a fire has occurred, the system may perform fire extinguishing operations for fire suppression.

Specifically, the fire suppression system 10 may obtain environment sensing information related to whether a fire occurs through the sensor unit 200. The sensor unit 200 may be provided in a preset area to obtain the environment sensing information, which is a basis for determining whether a fire occurs in the corresponding area. According to an embodiment, a plurality of sensor units 200 may be provided in an area to be sensed, and environment sensing information related to each corresponding space may be obtained. For example, the sensor unit 200 may include various sensor modules configured to measure temperature, humidity, carbon dioxide, oxygen concentration, and the like of the space where the sensor unit is located. That is, the sensor unit 200 may obtain environment sensing information (e.g., change in temperature, humidity, carbon dioxide, oxygen concentration, etc.) related to determining whether a fire occurs, and transmit the obtained environment sensing information to the controller 300. For example, the sensor unit 200 may transmit to the controller 300 environment sensing information indicating that the oxygen concentration in a first area is 20.9% v/v and the temperature is 200° C.

The specific description of the environment sensing information given above is merely an example, and the present disclosure is not limited thereto.

According to an embodiment of the present disclosure, the fire suppression system 10 may include a controller 300 configured to determine whether a fire has occurred based on the environment sensing information received through the sensor unit 200. According to one embodiment, the controller 300 may generally process overall operations of the fire suppression system 10. According to an embodiment, the controller 300 may provide appropriate information or functions to a user (or administrator) or process the same by processing input or output signals, data, information, etc., or by running application programs stored in a memory.

Specifically, the controller 300 may determine whether a fire has occurred based on the environment sensing information received from the sensor unit 200, and generate an operation control signal for control of the operation of the fire extinguishing unit 100 based on the determination of whether the fire has occurred. The controller 300 may determine whether the fire has occurred based on whether the environment sensing information exceeds a preset threshold.

For example, upon receiving, from the sensor unit 200, environment sensing information including information indicating that the oxygen concentration related to the first area is 5.9% v/v and the temperature is 200° C., the controller 300 may identify that the environment sensing information exceeds the preset threshold (e.g., the oxygen concentration of 60% and the temperature of 120° C.) and determine that a fire has occurred in the first area.

In addition, the controller 300 may determine whether a fire has occurred based on the amount of change in the environment sensing information. For example, upon receiving, from the sensor unit 200, environment sensing information including information indicating that the change in temperature in relation to the second area is 200° C. (i.e., the difference in temperature between a first point in time and a second point in time, which is a later point in time, is 200° C.), the controller 300 may identify that the amount of change in the environment sensing information exceeds a preset threshold amount of change (e.g., 30° C.) and determine that a fire has occurred in the second area. That is, the controller 300 may determine whether there is a fire based on the amount of change in the environment sensing information per unit time. The specific numerical values in the foregoing description are only examples for understanding of the present disclosure, and the present disclosure is not limited thereto.

As described above, the controller 300 may determine whether a fire has occurred based on the environment sensing information received from the sensor unit 200. Upon determining that a fire has occurred, the controller may generate an operation control signal for operating the fire extinguishing unit 100 and transmit the same to the fire extinguishing unit 100. For example, the operation control signal may be a control signal for controlling the operation of a gas supply unit 3000 supplying a fire extinguishing agent.

That is, the gas supply unit 3000 may perform an operation related to fire suppression by supplying a fire extinguishing agent to the fire extinguishing cylinder 2000 according to the operation control signal received from the controller 300. For example, the operation related to fire suppression may be related to an operation of extending a spray unit 1200 to the outside of the apparatus to discharge the fire extinguishing agent.

According to an embodiment of the present disclosure, the fire suppression system 10 may include a fire extinguishing unit 100 configured to suppress a fire by spraying an extinguishing agent. The fire extinguishing unit 100 may discharge the fire extinguishing agent to the outside when a fire occurs. Specifically, upon receiving an operation control signal from the controller 300, the fire extinguishing unit 100 may discharge the fire extinguishing agent to the outside based on the operation control signal. In this case, the fire extinguishing unit 100 may include a spray unit 1200 extended and exposed through the open upper end of the fire extinguishing unit 100.

The fire extinguishing unit 100 may include a spray mechanism by which the spray unit 1200 is exposed to the outside through an upper end of the fire extinguishing unit 100 when an operation control signal is received.

The spray unit 1200 may include a plurality of perforations formed to aim in multiple directions, and may spray the fire extinguishing agent in multiple directions through the plurality of perforations. That is, the spray unit 1200 may be located in the internal space of the fire extinguishing unit 100. When a fire occurs, the spray unit may be projected and exposed to the outside to spray the fire extinguishing agent in multiple directions through the plurality of perforations. The fire extinguishing unit 100 may include a plurality of extinguishing units spaced apart from each other by a predetermined distance within a specific space.

In an additional embodiment, the fire extinguishing unit 100 may include a heat sensing element configured to operate the spray unit 1200 when the temperature related to each area where the heat sensing element is provided reaches a specific critical temperature. That is, the fire extinguishing unit 100 may perform a fire extinguishing operation through the spray unit 1200 based on at least one of an operation control signal from the controller 300 or driving by the heat sensing element. The fire extinguishing unit 100 will be described later in detail with reference to the accompanying drawings.

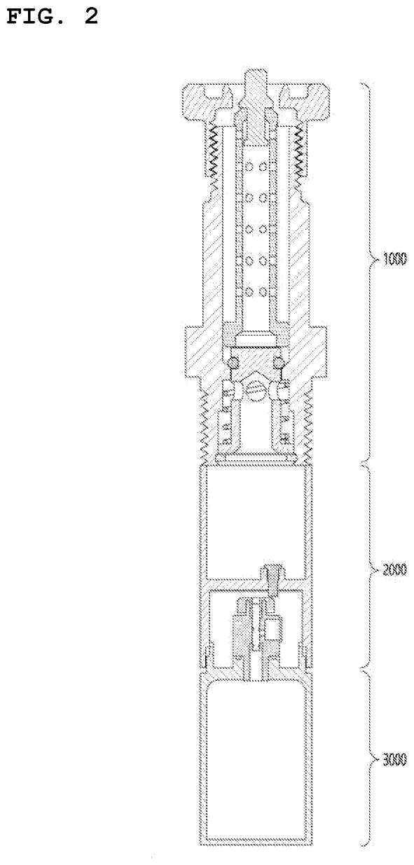

FIG. 2 is an exemplary view illustrating an assembly of a fire extinguishing unit according to an embodiment of the present disclosure. As shown in FIG. 2, the fire extinguishing unit 100 may include a valve structure 1000, a fire extinguishing cylinder 2000, and a gas supply unit 3000. The components shown in FIG. 2 are exemplary, and additional components may be provided or some of the components shown in FIG. 2 may be omitted.

According to an embodiment of the present disclosure, the fire extinguishing unit 100 may include the valve structure 1000 configured to discharge the fire extinguishing agent through a spray mechanism based on a difference between internal and external pressures. The spray mechanism may mean that the spray unit 1200 is exposed to the outside of the fire extinguishing unit 100 according to the pressure applied to the inside of the fire extinguishing unit 100.

Specifically, the valve structure 1000 may be provided at the upper end of the fire extinguishing unit 100, and may discharge the fire extinguishing agent to the outside through the spray mechanism. The valve structure 1000 may have a space for accommodating the fire extinguishing agent flowing in from the lower side. As the space is filled with the fire extinguishing agent, the spray unit 1200 may be exposed to the outside by the pressure difference generated between the inside and the outside. Once exposed to the outside, the spray unit 1200 may discharge the fire extinguishing agent in multiple directions through the plurality of perforations formed on the outer circumferential surface thereof.

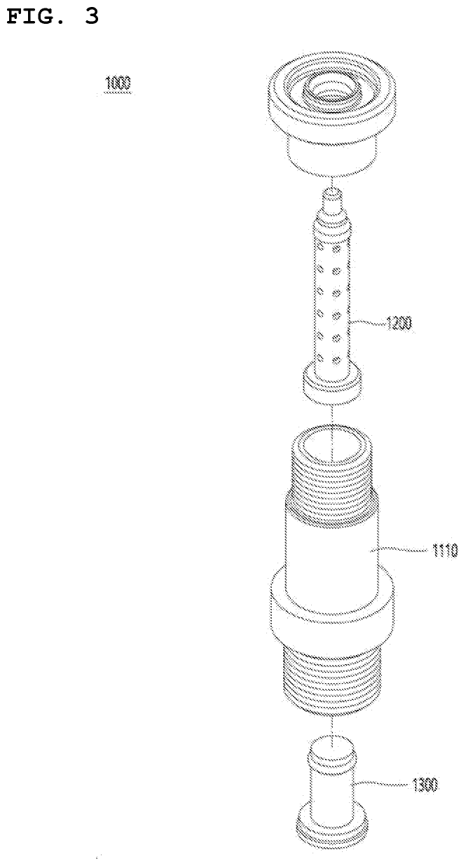

That is, the spray mechanism may be a mechanical mechanism that exposes the spray unit 1200 to the outside of the valve structure 1000 by the internal pressure that is increased due to the fire extinguishing agent flowing in from one side. The valve structure 1000 will be described below in more detail with reference to FIGS. 3 to 12.

FIG. 3 is an exploded view showing a valve structure according to an embodiment of the present disclosure. As shown in FIG. 3, the valve structure 1000 may include a body 1100, a spray unit 1200, and a control valve 1300. The components shown in FIG. 3 are exemplary, and additional components may be provided or some of the components shown in FIG. 3 may be omitted.

According to an embodiment of the present disclosure, the valve structure 1000 may include the body 1100, which may define an internal passage and include a discharge hole 1121 having a predetermined diameter. Here, the internal passage 1111 may represent a passage through which the spray unit 1200 is vertically movable inside the body 1100. The discharge hole 1121 may represent a passage through which the spray unit 1200 is exposed to the outside.

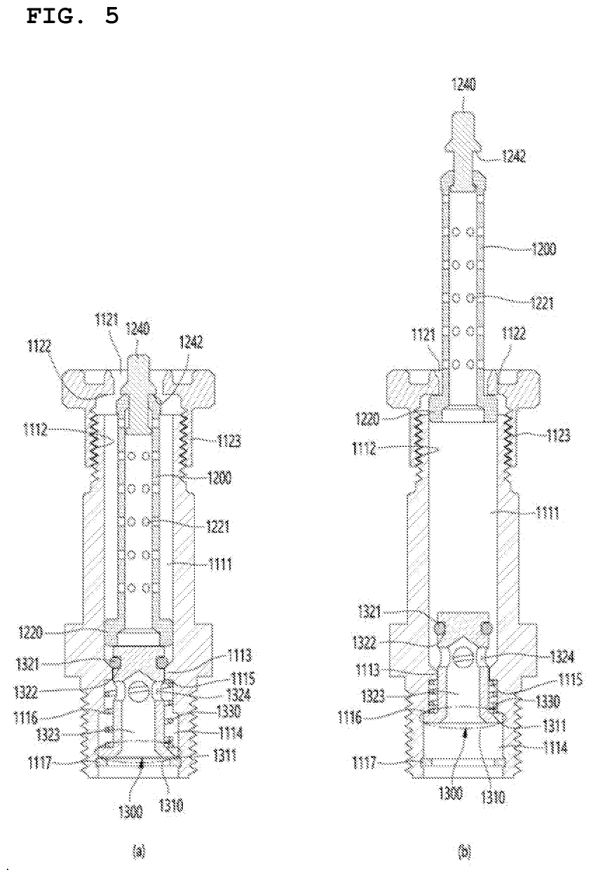

More specifically, the body 1100 may include a first body 1110 and a second body 1120. The body 1100 may include a first body 1110 defining the internal passage 1111 and having an outer rotation groove 1112, and a second body 1120 having an inner rotation groove 1123 rotationally coupled with the outer rotation groove 1112. For example, as shown in FIG. 5, the outer rotation groove 1112 may be provided through an inner diameter larger than the outer diameter of the inner rotation groove 1123, and the bodies may be rotationally coupled by the grooves corresponding to each other. In other words, a part of the second body 1120 may be penetrated by the first body 1110, and may be rotationally coupled therewith by the inner rotation groove 1123 and the outer rotation groove 1112 forming a coupling mechanism. As the rotation grooves are formed in the corresponding bodies so as to be screw-coupled with each other, convenience in fastening may be improved. In addition, by removing the second body 1120 from the first body 1110, the spray unit 1200 can be conveniently removed from the first body 1110 for maintenance purposes such as repairing or cleaning the spray unit 1200.

The first body 1110 may have a cylindrical shape and include the internal passage 1111 through which the spray unit 1200 is longitudinally movable. In addition, the first body 1110 may include an inwardly protruding step 1113, which protrudes inwardly, and a lower passage 1114 provided below the inwardly protruding step 1113. That is, the first body 1110 may be formed in a cylindrical shape defining a space inside thereof. Also, the internal passage 1111 may be formed above the inwardly protruding step 1113 formed on a portion of the first body to protrude inwardly, and a lower passage 1114 may be formed below the inwardly protruding step. Here, the internal passage 1111 of the first body 1110 may represent a passage through which the spray unit 1200 is movable, and the lower passage 1114 may represent a space where the control valve 1300 is provided. The control valve 1300 may be provided in the lower passage 1114 such that at least a part thereof may be moved into the internal passage 1111 by pressure, and may control the introduction of the fire extinguishing agent into the internal passage 1111. As shown in FIG. 5, the control valve 1300 may be supported by a control valve fixing part 1117, which is formed at the lower end of the lower passage 1114.

The second body 1120 may be rotationally coupled with the outer rotation groove 1112 provided in the first body 1110 to form the body 1100 of the present disclosure. The second body 1120 may include a discharge hole 1121 having a predetermined diameter. Here, the discharge hole 1121 may represent a passage through which the spray unit 1200 is exposed to the outside. The predetermined diameter of the discharge hole 1121 may be about the same or greater than the outer diameter of a lengthwise part 1220 of the spray unit 1200 and may be smaller than the diameter of a head 1210 of the spray unit 1200.

Accordingly, when the spray unit 1200 is raised by the pressure, the head 1210 cannot be exposed to the outside of the body 100 whereas a part of the spray unit 1200 may be exposed to the outside of the body 1100. As shown in FIG. 5, only the lengthwise part 1220 of the spray unit 1200 may be exposed to the outside of the body 1100, and the head 1210 having a larger diameter than the discharge hole 1121 may be resisted and supported by a spray unit support surface 1122 formed at the upper end of the body 1100. That is, the spray unit support surface 1122 supports the head 1210 of the spray unit 1200 when a part of the spray unit 1200 is exposed to the outside, thereby preventing the spray unit 1200 from being dislodged from the apparatus and improving the stability of the apparatus.

According to an embodiment of the present disclosure, the valve structure 1000 may include a spray unit 1200 arranged to be movable in the internal passage 1111 and exposed to the outside through the discharge hole 1121. For example, the spray unit 1200 may perform an up and down movement (or vertical movement) according to the pressure in the internal passage 1111 defined by the body 1100. The spray unit 1200 may be exposed to the outside through the discharge hole 1121 by the pressure applied to the inside of the body 1100. At least a part of the lengthwise part 1220 of the spray unit 1200 may protrude outwardly from the body 1100 as the pressure is applied to the internal passage.

Here, the pressure may be the one internally generated as the fire extinguishing agent is supplied from the gas supply unit 3000. When the fire extinguishing agent is supplied into the internal passage 1111 of the body 1100, the internal pressure may rise and have a difference from the external pressure. When the difference in pressure increases, the spray unit 1200 may be raised and exposed to the outside through the discharge hole 1121 formed at the upper end of the fire extinguishing unit 100. The spray unit 1200 may be formed of, for example, a material having high mechanical strength and exhibiting excellent abrasion resistance, impact resistance, and corrosion resistance.

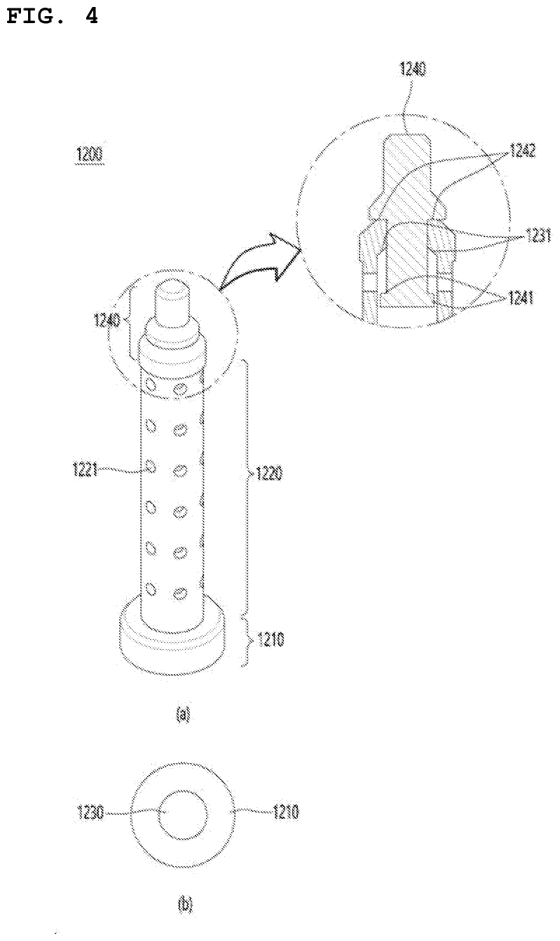

More specifically, as shown in FIG. 4, the spray unit 1200 may include a head 1210, a lengthwise part 1220, a center hole 1230, and a spray protrusion 1240. The spray unit 1200 may include a head 1210 having a diameter corresponding to the inner diameter of the internal passage and configured to perform a vertical movement according to the pressure applied to the inside of the body.

The spray unit 1200 may also include the lengthwise part 1220 extending from the head 1210 in one direction and having a plurality of perforations 1221 formed therein. At least a portion of the lengthwise part 1220 may protrude outwardly from the body 1100 according to pressure applied to the inside of the body 1100. The plurality of perforations 1221 allowing a fire extinguishing agent to be sprayed to the outside therethrough may be formed in the lengthwise part 1220. The plurality of perforations 1221 may be connected to the center hole 1230.

The spray unit 1200 may also include the center hole 1230 longitudinally formed inside the head 1210 and the lengthwise part 1220 and connected to the plurality of perforations 1221. That is, the center hole 1230 may be formed to extend through the spray unit 1200 in the longitudinal direction of the lengthwise part 1220 and be connected to the plurality of perforations 1221. Accordingly, the fire extinguishing agent may be supplied toward the head 1210 and then sprayed to the outside through each of the plurality of perforations 1221 via the center hole 1230.

The center hole 1230 is formed from the head 1210 through the lengthwise part 1220, and the diameter of the center hole 1230 may be smaller than the diameter of the head 1210 and the diameter of the lengthwise part 1220. In addition, the outer diameter of the head 1210 may be about the same or smaller than the diameter of the internal passage 1111 defined by the body 1100. For example, when the inner diameter of the internal passage 1111 is 2 cm, the diameter of the head 1210 may be 1.9 cm. Specific numerical values related to the aforementioned diameters are merely examples, and the present disclosure is not limited thereto.

That is, as the head 1210 of the spray unit 1200 is formed to have a diameter smaller than that of the internal passage 1111, the spray unit 1200 may perform an up and down movement (or vertical movement) according to a pressure generated inside the internal passage 1111. That is, the diameter of the internal passage 1111 may be larger than the diameter of the head 1210.

As shown in FIG. 5, the up and down movement (or vertical movement) may mean that the spray unit 1200 moves upward or downward according to the pressure inside the internal passage 1111. For example, FIG. 5-(a) may show the location of the spray unit 1200 given when a fire does not occur, that is, before the fire extinguishing unit 100 starts operating. FIG. 5-(b) may show the location of the spray unit 1200 exposed to the outside when the fire extinguishing unit 100 operates as a fire occurs.

According to an embodiment, the head 1210 may include a shock absorber configured to disperse an impact applied to the spray unit 1200. The shock absorber may be arranged on one surface of the head 1210. Referring to FIG. 5, when the shock absorber is raised in an upward direction according to the pressure, an impact caused by contact between the head 1210 and the body (i.e., the spray unit support surface 1122) may be minimized by the shock absorber formed on one surface of the head 1210. For example, the shock absorber may be formed of at least one of silicone, rubber, and urethane.

However, the shock absorber is not limited to the above-mentioned materials, and the material of the shock absorber may include various materials for dispersing, by a predetermined modulus of elasticity, a mechanical shock generated when the head 1210 and the body 1100 come into contact.

As a specific example, when a fire occurs, the fire extinguishing agent may be supplied into the internal passage 1111 of the body 1100 through the connection unit 2200, and the spray unit 1200 may be raised and exposed to the outside according to the increase in internal pressure as shown in FIG. 5-(b). In this case, the body 1100 may support the head 1210 through the spray unit support surface 1122, thereby preventing the spray unit 1200 from being completely separated from the fire extinguishing unit 100.

Here, since the exposure of the spray unit 1200 is achieved through an increase in pressure, the apparatus may be damaged due to a shock caused when the head 1210 and the spray unit support surface 1122 come into contact with each other.

Accordingly, a shock absorber formed of a cushioning material may be provided on one surface of the head 1210 that is brought into contact with the spray unit support surface 1122 when the spray unit 1200 is exposed to the outside by pressure. Accordingly, the shock caused by a contact between the body 1100 and the head 1210 may be minimized, and the stability of the apparatus may be secured. That is, damage to the spray unit 1200 or the body 1100 may be prevented by the shock absorber, and accordingly the operation efficiency of the apparatus may be improved.

The spray unit 1200 may include a spray protrusion 1240 provided at one end of the lengthwise part 1220 that is opposite the head 1210. As shown in FIG. 4, the spray protrusion 1240 may be provided at one end of the spray unit 1200 with the lengthwise part 1220 interposed therebetween.

Specifically, the spray protrusion 1240 may be provided at one end of the center hole 1230. Here, the one end of the center hole 1230 may be one end that is opposite the head 1210. In this case, a spray protrusion support surface 1231 may be provided at the one end of the center hole 1230 to prevent the spray protrusion 1240 from being completely separated from the body 1100.

As shown in FIG. 4, the spray protrusion 1240 may be arranged through the one end of the center hole 1230 to make a movement within a predetermined range limited by a spray protrusion support step 1241 and a spray surface 1242. Here, the movement within the predetermined range may mean a movement limited by the spray protrusion support step 1241 and the spray surface 1242 as shown in FIGS. 4, 5-(a), and 5-(b).

The spray protrusion 1240 may be raised by the pressure applied to the center hole 1230. When the spray protrusion 1240 is raised, a passage for discharging the fire extinguishing agent may be formed between the gap between the spray protrusion and the center hole 1230.

The spray protrusion 1240 may include the spray protrusion support step 1241 configured to contact the spray protrusion support surface 1231 formed around the center hole 1230 when the spray protrusion is raised by the pressure applied to the lengthwise part 1220. For example, when the spray protrusion 1240 is raised by the pressure applied to the center hole 1230, the spray protrusion support step 1241 may be brought into contact with the spray protrusion support surface 1231 formed at one end of the center hole 1230. Thus, the spray protrusion 1240 may be prevented from being completely separated from the spray unit 1200.

The spray protrusion 1240 may include a spray surface 1242 located above the spray protrusion support 1241 and having a step shape protruding along the outer circumferential surface of the spray protrusion. The spray surface 1242 may be provided to cause the fire extinguishing agent supplied from the center hole 1230 to be sprayed in multiple directions.

For example, when a fire occurs, the fire extinguishing agent may be supplied into the internal passage 1111 of the body 1100 through the connection unit 2200, and the spray unit 1200 may be raised and exposed to the outside according to the increase in internal pressure. The increase in internal pressure applies pressure to the center hole 1230, and the spray protrusion 1240 is raised by the pressure applied through the center hole 1230, as shown in FIG. 5-(b). When the spray protrusion 1240 projects to bring the spray protrusion support 1241 into contact with the spray protrusion support surface 1231 formed at one end of the center hole 1230, a passage for the discharge of the fire extinguishing agent will be formed through the gap between the spray protrusion 1240 and the center hole 1230.

For example, the diameter of the spray protrusion 1240 between the spray protrusion support step 1241 and the spray surface 1242 may be smaller than the diameter formed by the center hole 1230. Accordingly, the fire extinguishing agent may be discharged through the passage secured according to the difference in diameter between the spray protrusion 1240 and the center hole 1230.

The fire extinguishing agent may be discharged through the passage secured through the gap between the spray protrusion 1240 and the center hole 1230. In this case, the spray protrusion 1240 protruding through the center hole 1230 may have a smaller diameter than the center hole 1230. As the spray protrusion is fixed to the spray unit 1200 by the spray protrusion support step 1241, the spray protrusion 1240 may move at various angles with respect to the lengthwise part 1220 during the discharge of the fire extinguishing agent. Accordingly, the fire extinguishing agent may be sprayed in multiple directions.

Additionally, when the fire extinguishing agent is discharged through the passage formed as the spray protrusion 1240 rises from the spray unit 1200, the discharged fire extinguishing agent is sprayed onto the spray surface 1242 formed on the upper side of the spray protrusion 1240 and dispersed in all directions. In this case, the spray protrusion 1240 may discharge the fire extinguishing agent in various angular ranges while moving at various angles with respect to the lengthwise part 1220 during the discharge of the fire extinguishing agent. Additionally, the fire extinguishing agent may be sprayed in multiple directions by the spray surface 1242. In other words, the fire extinguishing agent may be discharged to a wider area by utilizing the spray surface 1242.

According to an embodiment of the present disclosure, the valve structure 1000 may include a control valve 1300. The control valve 1300 may be arranged in the lower passage 1114 such that at least a part thereof may be moved to the internal passage 1111 by pressure, and may control the inflow of the fire extinguishing agent into the internal passage 1111. The control valve 1300 may control the introduction of the fire extinguishing agent into the internal passage 1111 located on the upper side of the body 1100 according to the pressure caused by the fire extinguishing agent supplied through the connection unit 2200 located below the body 1100.

For example, the control valve 1300 may control the fire extinguishing agent to be delivered to the internal passage located on the upper side when the lower passage 1114 reaches a predetermined pressure or higher due to the continuous supply of the fire extinguishing agent. That is, when the control valve 1300 is subject to a pressure higher than or equal to the predetermined pressure due to the continuous supply of the fire extinguishing agent, the fire extinguishing agent may be delivered to the internal passage 1111. Here, the predetermined pressure may be based on the elastic force of a spring 1330, which will be described below.

Specifically, the control valve 1300 may include a control valve head 1310 configured to move up and down according to the applied pressure. The control valve head 1310 may be raised by the applied pressure as the fire extinguishing agent is supplied through the connection unit 2200 located on the lower side.

In addition, the control valve 1300 may include a control valve lengthwise part 1320 extending from the control valve head 1310 in one direction and having a plurality of agent discharge holes 1324. The control valve 1300 may include a control valve center hole 1323 longitudinally formed inside the control valve head 1310 and the control valve lengthwise part 1220 and connected to the plurality of agent discharge holes 1324. That is, the control valve center hole 1323 may be formed in the longitudinal direction of the control valve lengthwise part 1320 and connected to the plurality of agent discharge holes 1324. Accordingly, the fire extinguishing agent may be supplied toward the control valve head 1310 and delivered into the internal passage 1111 through the plurality of agent discharge holes 1324 via the control valve center hole 1323.

In addition, the control valve 1300 may include a spring 1330 having one end connected to one surface of the control valve head 1310 and the other end connected to an inner portion of the body 1100 to control a vertical movement of the control valve head 1310. As shown in FIG. 5, the spring 1330 may be formed in a shape surrounding the outer circumferential surface of the control valve 1300. The one end of the spring 1330 may be connected to one surface of the control valve head 1310, that is, the spring support surface 1311, and the opposite end thereof may be connected to one surface of the inwardly protruding step 1113 formed inside the body 1100, that is, to the first support surface 1115. The control valve 1300 of the present disclosure may move upward and downward by the elastic force of the spring 1330 and the pressure applied in the downward direction.

More specifically, referring to FIG. 5, the pressure applied to the control valve 1300 may be increased by the fire extinguishing agent supplied from the lower side. As the fire extinguishing agent is continuously supplied, the control valve 1300 may be raised while the spring 1330 is compressed by the pressure applied to the control valve 1300. When the control valve 1300 is raised, a portion of the control valve 1300 may move into the internal passage 1111. That is, as shown in FIG. 5-(b), the plurality of agent discharge holes 1324 may be moved into the internal passage 1111. In this case, as the spring support surface 1311 of the control valve head 1310 contacts the second support surface 1116 formed on the first body 1110, the rise of the control valve 1300 may be controlled. That is, the maximum height of rise of the control valve 1300 may be controlled by the second support surface 1116 formed on the first body 1110.

The fire extinguishing agent may be supplied into the control valve center hole 1323. Then, the fire extinguishing agent may be introduced into the internal passage 1111 through the plurality of the agent discharge holes 1121 moved into the internal passage 1111. When the supply of the fire extinguishing agent from the lower side (i.e., the connection unit) stops, the pressure applied to the control valve 1300 may be reduced. Then, the control valve 1300 is moved downward due to the resilience of the spring 1330. The plurality of agent discharge holes 1324 may return to the lower passage 1114. That is, the passage through which the fire extinguishing agent is discharged into the internal passage 1111 may be blocked.

In addition, the control valve fixing part 1117 may be provided under the control valve 1300. The control valve fixing part 1117 may protrude toward the inside of the lower passage to support and fix the control valve 1300 in the lower passage 1114. That is, the control valve 1300 may be supported or fixed at one position in the lower passage 1114 by the control valve fixing part 1117.

According to an embodiment, a packing member may be provided in a first area of the control valve 1300. Here, the first area may be an area where the control valve 1300 may contact the inwardly protruding step 1113 by the packing member 1321 when the control valve 1300 is in a lowered position (e.g., the position of the control valve in FIG. 5-(a)). Thus, the control valve 1300 may be provided with a packing groove 1322 into which the packing member 1321 is inserted. That is, the packing groove 1322 is formed in the first area of the control valve 1300, and the packing member 1321 may be arranged in the packing groove 1322. Accordingly, when the control valve 1300 is placed in the lowered position (e.g., the position of the control valve in FIG. 5-(a)), the movement of the gas (e.g., the fire extinguishing agent) may be blocked by the packing member 1321. The packing member 1321 may prevent the pressure in the lower passage from being transmitted to the internal passage 1111, and accordingly the spring 1330 may be compressed by the pressure generated by the fire extinguishing agent in the lower passage 1114. In addition, the control valve 1300 may contact the head 1210 of the spray unit 1200 when the pressure is not applied such that the pressure applied to the control valve 1300 vertically moves the control valve 1300, which in turn vertically moves the head 1210 of the spray unit 1200.

Additionally, as the packing member 1321 is provided, the gas or fluid may be blocked from unnecessarily moving from the internal passage 1111 toward the lower passage 1114 or from the lower passage 1114 toward the internal passage when the apparatus is not operating. Accordingly, the efficiency of the apparatus may be improved in terms of service life.

According to an embodiment of the present disclosure, the fire extinguishing unit 100 may include a fire extinguishing cylinder 2000 configured to deliver the fire extinguishing agent to the valve structure 1000. As shown in FIG. 2, the fire extinguishing cylinder 2000 is disposed between the valve structure 1000 and the gas supply unit 3000 to deliver the fire extinguishing agent supplied from the gas supply unit 3000 to the valve structure 1000.

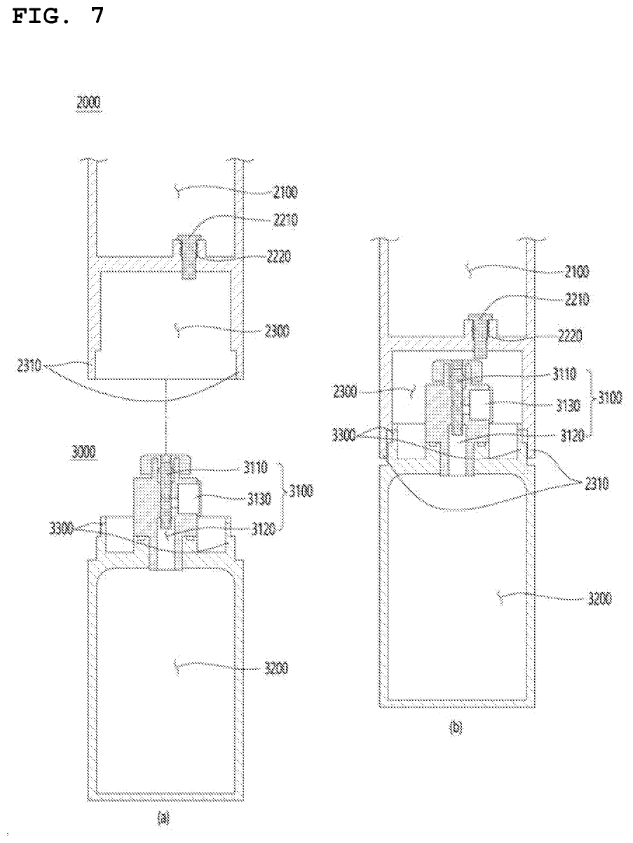

Specifically, as shown in FIG. 7, the fire extinguishing cylinder 2000 may include an inner space 2100 connected to the valve structure 1000 to apply pressure. The inner space 2100 may be a space for accommodating the fire extinguishing agent delivered through the connection unit 2200. For example, when the amount of the fire extinguishing agent accommodated in the inner space 2100 through the connection unit 2200 is increased, pressure may be applied to the valve structure 1000 (i.e., the internal passage) connected to the inner space 2100. That is, the increase of the fire extinguishing agent accommodated in the inner space 2100 may increase the pressure to the internal passage 1111 to open an opening/closing part 1400. Thereby, the spray unit 1200 may be moved and exposed to the outside.

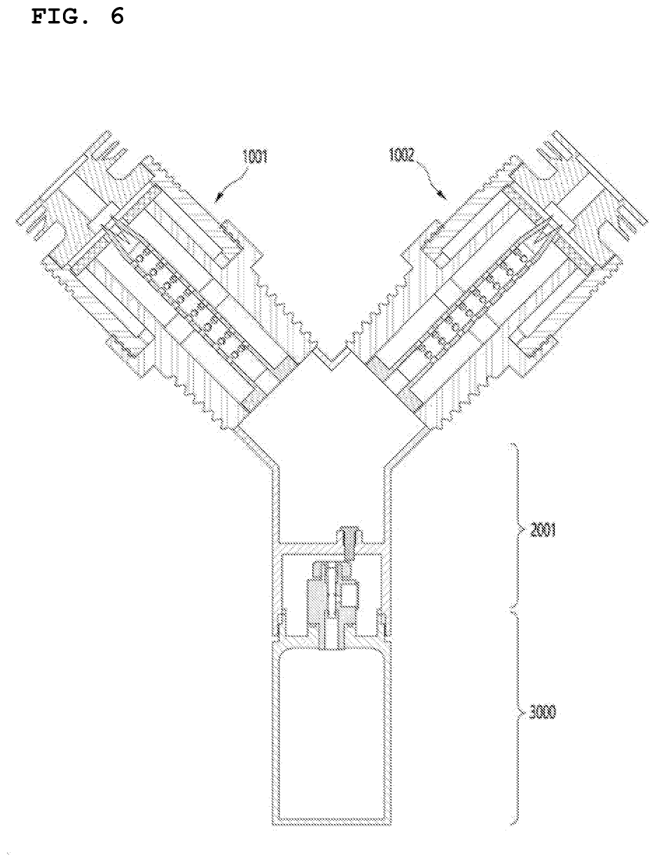

According to another embodiment of the present disclosure, the internal space 2100 of the fire extinguishing cylinder 2000 may be formed in a Y-shape to deliver the fire extinguishing agent to each of the two valve structures. FIG. 6 is an exemplary view illustrating a y-shaped fire extinguishing cylinder 2000 according to another embodiment of the present disclosure. As shown in FIG. 6, the y-shaped fire extinguishing cylinder 2000 may be connected to each of a first valve structure 1001 and a second valve structure 1002, and may apply pressure to each of the internal passages of each valve structure 1000 according to the supply of the fire extinguishing agent. In this case, the fire extinguishing agent may be discharged through the spray unit 1200 exposed to the outside in more various directions. Accordingly, a fire suppression range may be widened and thus fire suppression efficiency may be improved. Additionally, multiple valve structures may be integrated into one fire extinguishing cylinder and the gas supply unit (i.e., the number of valve structures provided in the fire extinguishing cylinder and the gas supply unit may be maximized), thereby reducing manufacturing costs.

Also, the fire extinguishing cylinder 2000 may include a connection unit 2200 for delivering the fire extinguishing agent to the inner space. The connection unit 2200 may be opened and closed to control the fire extinguishing agent delivered to the internal space 2100.

Specifically, the connection unit 2200 may include a shut-off valve 2210 and a lower connection groove 2220 as shown in FIG. 7. The shut-off valve 2210 may be arranged to be movable in the lower connection groove 2220 by tension of an elastic spring surrounding the outer circumferential surface of the shut-off valve 2210. In this case, a packing member may be formed on one side such that the lower connection groove 2220 may be opened or closed by a pressure difference. Specifically, when the fire extinguishing agent is filled in the fire extinguishing cylinder at an initial high pressure, the shut-off valve 2210 may close the lower connection groove 2220 by compressing the elastic spring by the pressure generated by the fire extinguishing agent. When the fire extinguishing agent is discharged to the outside according to the occurrence of a fire, the lower connection groove 2220 may be opened as the internal pressure is reduced to restore the elastic spring.

In one embodiment, the shut-off valve 2210 may have a packing member. When positioned to close the lower connection groove 2220, the packing member may closely contact the inner wall to prevent the fire extinguishing agent from entering the internal space 2100. When positioned to close the lower connection groove 2220, the packing member may move along with the shut-off valve 2210 to be separated from the inner wall to form a passage through which the fire extinguishing agent moves.

The fire extinguishing cylinder 2000 may further include a lower space 2300 including a lower coupling portion 2310 for coupling with the gas supply unit 3000. For example, when the fire extinguishing cylinder 2000 is coupled to the gas supply unit 3000 by the lower coupling portion 2310, the lower space 2300 may become an airtight space.

According to an embodiment of the present disclosure, the fire extinguishing unit 100 may include a gas supply unit 3000 configured to contain the fire extinguishing agent therein and supply the same to the fire extinguishing cylinder 2000. The gas supply unit 3000 may include a storage unit 3200 to accommodate the fire extinguishing agent therein, a supply unit for discharging the stored fire extinguishing agent into the lower space, and a coupling portion 3300 forming a coupling mechanism for coupling with the fire extinguishing cylinder.

The gas supply unit 3000 may include the coupling portion 3300 coupled to the fire extinguishing cylinder 2000. Specifically, as shown in FIG. 7, the coupling portion 3300 may be coupled to the lower coupling portion 2310 of the fire extinguishing cylinder 2000 to seal the lower space 2300. That is, the lower coupling portion 2310 and the coupling portion 3300 may be coupled on the lower side of the fire extinguishing cylinder 2000. When the lower coupling portion 2310 and the coupling portion 3300 are coupled, the lower space 2300 may be formed between the fire extinguishing cylinder 2000 and the gas supply unit 3000.

The gas supply unit 3000 may further include a supply unit 3100 configured to discharge the fire extinguishing agent. The supply unit 3100 may include an outlet 3130 through which the fire extinguishing agent is discharged, a shaft 3110 configured to open and close the outlet 3130, and a through-hole 3120 allowing the supply of the fire extinguishing agent.

Specifically, before the gas supply unit 3000 is coupled to the fire extinguishing cylinder 2000, the shaft 3110 protrudes from the through-hole 3120 and is engaged with a safety pin to prevent the gas filled therein from being discharged. By removing the safety pin before the fire extinguishing cylinder 2000 is coupled, the fire extinguishing agent may be supplied to the lower space 2300. Accordingly, as the fire extinguishing agent is discharged to the outside through the fire extinguishing unit 100 of the present disclosure, the internal pressure of the fire extinguishing cylinder 2000 may be reduced below the gas pressure in the lower space 2300. In this case, the elastic spring provided inside the shut-off valve 2210 may be compressed such that the shut-off valve 2210 moves and the lower connection groove 2220 is opened to secure a passage, through which the fire extinguishing agent may be introduced. Thereby, the pressure inside the fire extinguishing cylinder 2000 may be increased to promote discharge of the fire extinguishing agent.

In this case, the shaft 3110 may be provided with an elastic spring and a packing member. Thus, when the safety pin is fixed, the elastic spring is maintained in a tensioned state, and the packing member, which may be formed on opposing sides of the outlet 3130, may prevent the fire extinguishing agent from being discharged. When the safety pin is removed, the shaft may be moved as the elastic spring is restored. In addition, as one packing member is disposed in the through-hole 3120, a passage through which the fire extinguishing agent may move to the outlet 3130 may be formed.

Therefore, as the fire extinguishing unit 100 of the present disclosure is provided with the shut-off valve 2210 that is opened and closed by a pressure difference, the fire extinguishing agent may be continuously sprayed at a constant pressure and fully discharged to the outside such that no fire extinguishing agent is left inside. Accordingly, the fire extinguishing agent filled in the gas supply unit 3000 may be entirely consumed, thereby addressing the issue of waste of the fire extinguishing agent.

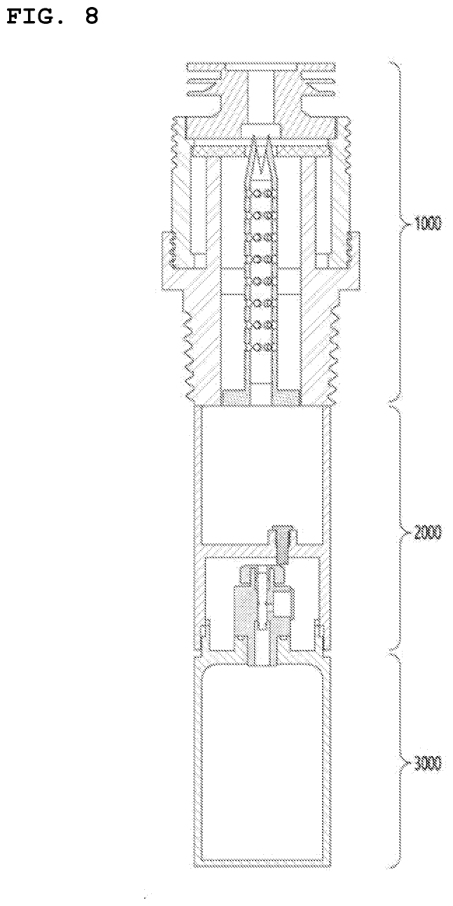

Hereinafter, a fire extinguishing unit related to another embodiment of the present disclosure will be described with reference to FIGS. 8 to 14.

FIG. 8 is an exemplary view illustrating an overall assembly of a fire extinguishing unit according to another embodiment of the present disclosure. As shown in FIG. 8, the fire extinguishing unit 100 may include a valve structure 1000′, a fire extinguishing cylinder 2000, and a gas supply unit 3000. The components shown in FIG. 8 are exemplary, and additional components may be provided or some of the components shown in FIG. 8 may be omitted.

According to an embodiment of the present disclosure, the fire extinguishing unit 100 may include a valve structure 1000′ configured to discharge the fire extinguishing agent through a spray mechanism based on a difference between internal and external pressures. The spray mechanism may mean opening the opening/closing part 1400 through movement of the spray unit 1200′ according to the pressure applied from the inside of the fire extinguishing unit 100. Specifically, the valve structure 1000′ may be provided at the upper end of the fire extinguishing unit 100, and may discharge the fire extinguishing agent to the outside through the spray mechanism. The valve structure 1000′ may have a space for accommodating the fire extinguishing agent flowing in from the lower side. As the fire extinguishing agent is filled in the space, the spray unit 1200′ may be exposed to the outside by the pressure difference generated between the inside and the outside. Once exposed to the outside, the spray unit 1200′ may discharge the fire extinguishing agent in multiple directions through a plurality of perforations formed in the outer circumferential surface thereof.

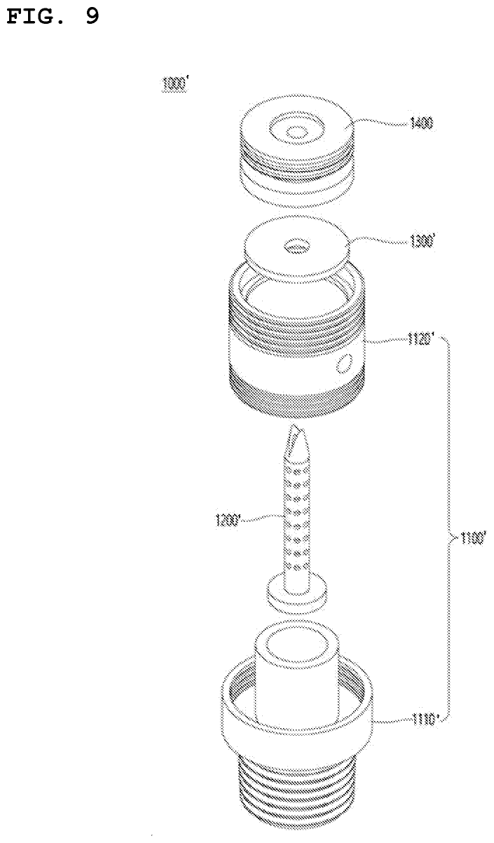

That is, the spray mechanism may be a mechanical mechanism that opens the opening/closing part 1400 by the internal pressure increased by the fire extinguishing agent introduced from one side, and exposes the spray unit 1200′ to the outside at the other side (i.e., the upper end opened by the opening/closing part) corresponding to the one side. The valve structure 1000′ will be described below in more detail with reference to FIGS. 9 to 14.

FIG. 9 shows an overall exploded view of a valve structure according to one embodiment of the present disclosure. As shown in FIG. 9, the valve structure 1000′ may include a body 1100′, a spray unit 1200′, a bearing 1300′, and an opening/closing part 1400. The components shown in FIG. 9 are exemplary, and additional components may be provided or some of the components shown in FIG. 9 may be omitted.

According to an embodiment of the present disclosure, the valve structure 1000′ may include a body 1100′ defining an internal passage 1111′. Here, the internal passage 1111′ may represent a passage through which the spray unit 1200′ moves inside the body 1100′. More specifically, the body 1100′ may include a first body 1110′ and a second body 1120′. The body 1100′ may include a first body 1110′ defining the internal passage 1111′ and having a first coupling portion 1112′, and a second body 1120′ coupled to the first body 1110′ through the first coupling portion 1112′. In other words, the first body 1110′ and the second body 1120′ may be coupled through the first coupling portion 1112′ to form the body 1100′ of the present disclosure.

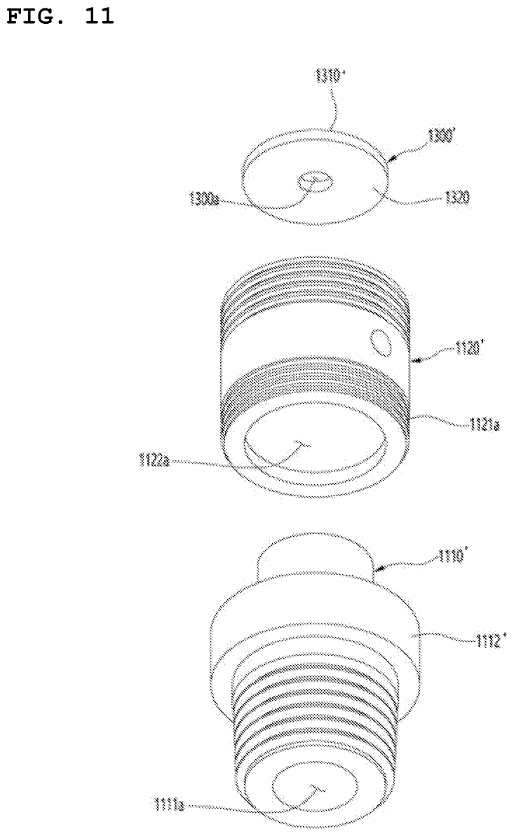

The first body 1110′ may have a cylindrical shape and include a first coupling portion 1112′ protruding from at least a portion thereof. For example, as shown in FIG. 11, the first coupling portion 1112′ may protrude from at least a portion of the outer surface of the first body 1110′ and may include an inner rotation groove 1112a on the inside thereof. The first body 1110′ may be coupled to the second body 1120′ through the inner rotation groove 1112a of the first coupling portion 1112′. In this case, the inner diameter formed by the first coupling portion 1112′ may be larger than the outer diameter of the second body 1120′.

The second body 1120′ may be formed in a cylindrical shape to define an internal passage 1122′ and may be coupled to the first coupling portion 1112′. Here, the internal passage 1122′ may represent a hole into which at least a portion of the first body 1110′ is inserted. Specifically, referring to FIG. 11, the second body 1120′ may have an outer rotation groove 1121a formed in at least a portion of the outer circumferential surface thereof, and may be rotationally coupled with the inner rotation groove 1112a of the first coupling portion 1112′ provided in the first body 1110′. In this case, the internal passage 1122′ of the second body 1120′ may be formed to have an inner diameter larger than the outer diameter of the first body 1110′, and be fitted onto a portion of the first body 1110′. That is, as the internal passage diameter 1122a is formed to be larger than the outer diameter of a portion of the first body 1110′, a portion of the first body 1110′ may extend through the second body 1120′. The second body may include an outer rotation groove 1121a forming a coupling mechanism for coupling with the first coupling portion 1112′. In other words, as the rotation grooves are formed in the corresponding bodies so as to be screw-coupled with each other, convenience in fastening may be improved.

In addition, an inner support step 1122b protruding inward may be provided in a portion of the internal passage 1111′ defined by the second body 1120′. The inner support step 1122b is provided to support the bearing 1300′, and may protrude toward the center such that the diameter of a portion of the internal passage 1111′ is smaller than the outer diameter of the bearing 1300′.

That is, the bearing 1300′ may be seated in a portion of the internal passage 1111′ by the inner support step 1122b, rather than completely passing through the internal passage 1111′. In other words, a portion of the inner support step 1122b may directly contact a portion of the bearing 1300′. Thereby, the bearing 1300′ supporting the spray unit 1200′ in relation to the operation of the valve structure 1000′ of the present disclosure may be prevented from being separated. That is, the inner support step 1122b may prevent the bearing 1300′ from being separated, thereby improving the stability of the apparatus.

According to an embodiment of the present disclosure, the valve structure 1000′ may include a spray unit 1200′ including a plurality of through-holes 1232 formed to be movable in the internal passage 1111′ and to discharge the fire extinguishing agent to the outside. For example, the spray unit 1200′ may perform an up-down movement (or vertical movement) according to pressure in the internal passage 1111′ defined by the body 1100′. Here, the pressure may be the one generated inside as the fire extinguishing agent is supplied from the gas supply unit 3000′. When the fire extinguishing agent is supplied into the internal passage 1111′ of the body 1100′, the internal pressure may rise and have a difference from the external pressure. When the difference in pressure increases, the opening/closing part 1400 positioned at the upper end of the fire extinguishing unit 100 may be opened, and the spray unit 1200′ may be raised and exposed to the outside. The spray unit 1200′ may be formed of, for example, a material having high mechanical strength and exhibiting excellent abrasion resistance, impact resistance, and corrosion resistance.

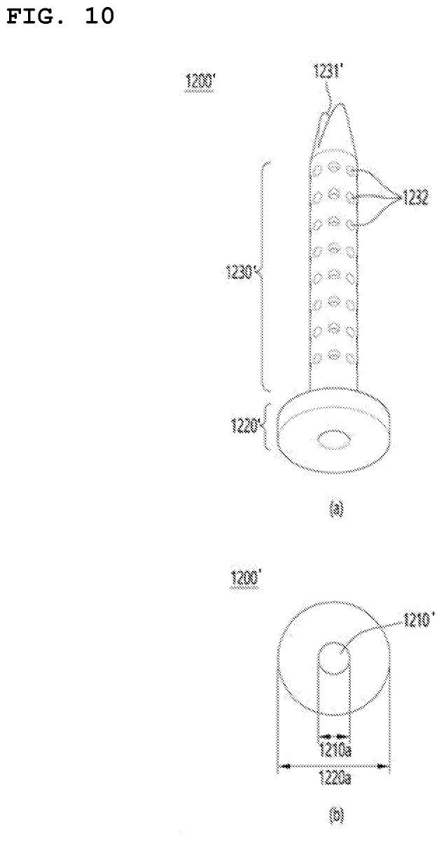

More specifically, as shown in FIG. 10, the spray unit 1200 may include a head 1220′, a lengthwise part 1230′, and a center hole 1210′. The spray unit 1200′ may include a head 1220′ having a diameter corresponding to the diameter of the internal passage 1111′ and configured to perform a vertical movement according to the pressure applied to the inside of the body 1100′.

The spray unit 1200′ may also include the lengthwise part 1230′ extending from the head 1220′ in one direction and having a plurality of perforations 1232 formed therein. At least a portion of the lengthwise part 1230′ may protrude outward from the body 1100′ according to pressure applied to the inside of the body 1100′. The lengthwise part 1230′ may include an edge portion 1231′ and a plurality of perforations 1232. The edge portion 1231′ may be provided at one end of the lengthwise part 1230′ and be arranged to contact one surface of the opening/closing part 1400. The edge portion 1231′ may be connected to the center hole 1210′ and formed such that the spray unit 1200′ has a spray angle within a specific range in the upward direction. That is, the edge portion 1231′ may form a spray angle within a specific range such that the discharged fire extinguishing agent has a discharging direction.

The spray unit 1200′ may also include the center hole 1210′ formed inside along the longitudinal direction of the head 1220′ and the lengthwise part 1230′ and connected to the plurality of perforations 1232. That is, the center hole 1210′ may be formed to extend through the spray unit 1200′ in the longitudinal direction of the lengthwise part 1230′ and be connected to each of the plurality of perforations 1232 and the edge portion 1231′. In other words, each of the plurality of perforations 1232 and the edge portion 1231′ may be connected to the center hole 1210′ formed in the longitudinal direction. Accordingly, the fire extinguishing agent may be supplied toward the head 1220′ and discharged through the plurality of perforations 1232 and the edge portion 1231′ via the center hole 1210′.

That is, when the fire extinguishing agent is delivered through the connection unit 2200′ and supplied into the internal passage 1111′ of the body 1100′, the opening/closing part 1400 may be opened by the movement of the spray unit 1200′ caused by the increase in the internal pressure, and the spray unit 1200′ may be raised to the open upper end and exposed to the outside. The spray unit 1200′ exposed to the outside may discharge the fire extinguishing agent in all directions through the edge portion 1231′ and the plurality of perforations 1232. Thereby, the fire extinguishing unit 100 may perform fire suppression corresponding to a specific area (e.g., the area having the fire extinguishing unit).

The center hole 1210′ is formed from the head 1220′ through the lengthwise part 1230′, and the center hole diameter 1210a may be smaller than the head diameter 1220a. In addition, the outer diameter of the head 1220′ may be smaller than the diameter of the internal passage 1111′ defined by the body 1100′. For example, when the inner diameter of the internal passage 1111′ is 2 cm, the head diameter 1220a may be 1.9 cm. Specific numerical values related to the aforementioned diameters are merely examples, and the present disclosure is not limited thereto.

That is, as the head 1220′ of the spray unit 1200′ is formed to have a diameter smaller than that of the internal passage 1111′, the spray unit 1200′ may perform an up-down movement (or vertical movement) according to a pressure generated inside the internal passage 1111′. That is, the internal passage diameter 1111a may be larger than the head diameter 1220a.

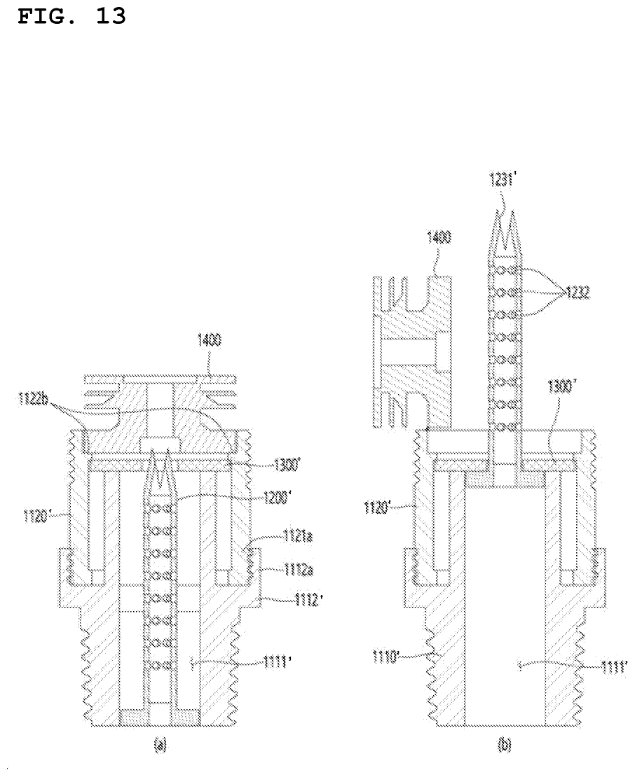

As shown in FIG. 13, the up-down movement (or vertical movement) may mean that the spray unit 1200′ moves upward or downward according to the pressure inside the internal passage 1111′. For example, FIG. 13-(a) may show the location of the spray unit 1200′ when a fire does not occur, that is, before the fire extinguishing unit 100 operates. FIG. 13-(b) may show the location of the spray unit 1200′ exposed to the outside when the fire extinguishing unit 100 operates as a fire occurs.

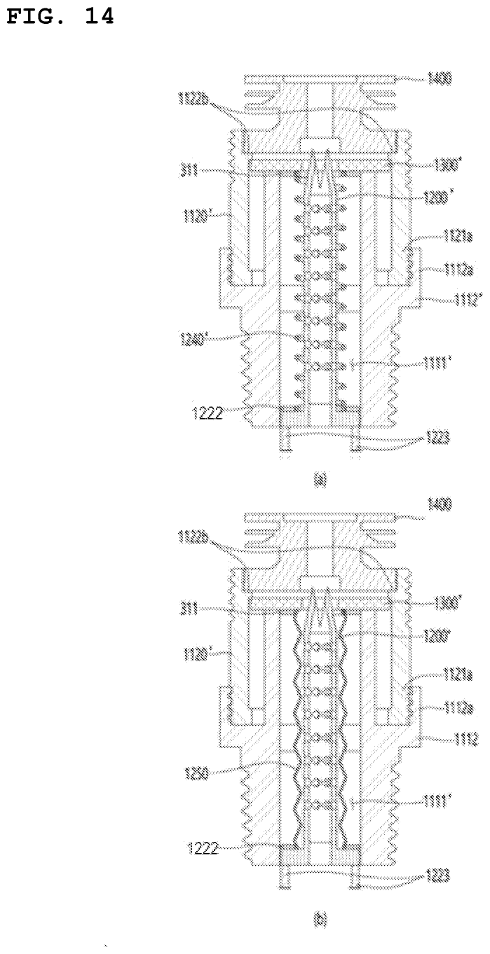

According to an embodiment of the present disclosure, the head 1220′ may include a shock absorber 1222 configured to disperse or absorb an impact applied to the spray unit 1200′. The shock absorber 1222 may be arranged on a part of the head 1220′. Specifically, as shown in FIG. 14, the shock absorber 1222 may protrude from one surface of the head 1220′ in relation to the direction of the lengthwise part 1230′. When the spray unit 1200′ moves upward according to the pressure in FIG. 14, the shock absorber may minimize damage caused by the impact by absorbing the impact caused by the contact between the bearing 1300′ and the head 1220′. For example, the shock absorber 1222 may be formed of at least one of silicone, rubber, and urethane. However, the shock absorber is not limited to the above-mentioned materials, and the material of the shock absorber may include various materials for dispersing, by a predetermined modulus of elasticity, a mechanical shock generated when the head 1220′ and the bearing 1300′ come into contact with each other.

As a specific example, when a fire occurs, the fire extinguishing agent may be supplied into the internal passage 1111′ of the body 1100′ through the connection unit 2200′, and the opening/closing part 1400 may be opened according to the increase in internal pressure, and the spray unit 1200′ may be raised and be exposed to the outside, as shown in FIG. 13-(b). In this case, the bearing 1300′ may be supported by the inner support step 1122b of the second body 1120′, and the spray unit 1200′ may be prevented from being completely separated from the fire extinguishing unit 100. The bearing 1300′ may include a through-hole 1300a having a diameter larger than the outer diameter of the lengthwise part 1230′ but smaller than the head diameter 1220a of the head 1220′. Accordingly, when the spray unit 1200′ is raised by the pressure, it may come into contact with one surface of the head 1220′. Thereby, the spray unit 1200′ may be prevented from being separated to the outside, while only the lengthwise part 1230′ may be exposed to the outside. Here, since the exposure of the spray unit 1200′ is achieved through an increase in pressure, the apparatus may be damaged due to a shock generated during the contact between the head 1220′ and the bearing 1300′.

Accordingly, the shock absorber 1222 formed of a cushioning material may be provided on one surface of the head 1220 that is brought into contact with the bearing 1300′ when the spray unit 1200′ is exposed to the outside by pressure. Accordingly, the shock caused by a contact between the bearing 1300′ and the head 1220′ may be minimized, and the stability of the apparatus may be secured. That is, damage to the spray unit 1200′ or the bearing 1300′ may be prevented by the shock absorber 1222, and accordingly the operation efficiency of the apparatus may be improved.

According to an embodiment of the present disclosure, the head 1220′ may include a movement guide part 1223. Specifically, the head 1220′ may include a movement guide part 1223 extending along the longitudinal direction of the internal passage 1111′ and having at least a portion contacting the inner circumferential surface of the internal passage 1111′.

For example, the movement guide part 1223 may be arranged on a portion of the head 1220′ to extend by a predetermined length. Accordingly, the movement guide part 1223 included in the head 1220′ extends by a predetermined length in a direction opposite to the direction in which the lengthwise part 1230′ extends, that is, in another direction opposite to one direction.

For example, referring to FIG. 14, at least a portion of the head 1220′ may include a movement guide part 1223 protruding in a direction opposite to the direction in which the lengthwise part 1230′ is extended.

The movement guide part 1223 of the present disclosure may be provided to prevent possible damages to the spray unit 1200′ by preventing the head unit 1220′ from being twisted and stuck in the internal passage 1111′ defined by the body 1100′ when the spray unit 1200′ is moved upward or downward by pressure.

As a specific example, when a fire occurs, the fire extinguishing agent may be supplied into the internal passage 1111′ of the body 1100′ through the connection unit 2200′, and the opening/closing part 1400 may be opened according to the increase in internal pressure, and the spray unit 1200′ may be raised and be exposed to the outside. In this case, as the spray unit 1200′ performs a vertical movement (or up and down movement) by the pressure generated by the supplied fire extinguishing agent, the head 1220′ may be twisted and stuck a portion of the internal passage 1111′ while the spray unit 1200′ rises. To prevent this issue, a movement guide part 1223 may be provided on a portion of the head 1220′. That is, as the movement guide part 1223 is provided on the head 1220′ to extend in one direction (e.g., a direction facing away from the lengthwise part), the area of contact with the inner wall of the internal passage 1111′ may be increased, and thus the spray unit 1200′ may be prevented from being inclined in the internal passage 1111′. In other words, the movement guide part 1223 may guide the head 1220′ to allow the spray unit 1200′ to smoothly perform a vertical movement in the internal passage 1111′, thereby preventing damage to the apparatus.

According to an embodiment of the present disclosure, the spray unit 1200′ may include a spring 1240′ configured to apply a restoring force to the head 1220′. Specifically, the spray unit 1200′ may include a spring 1240′ having one end connected to one surface of the head 1220′ and an opposite end connected to one surface of a bearing. The spring may be formed of an elastic material. Here, the spring 1240′ may be formed to surround the outer surface of the lengthwise part 1230′ by the spiral shape thereof between the one end and the opposite end. For example, as shown in FIG. 14-(a), the spring 1240′ may be formed in the coil shape that is wound around the outer circumferential surface of the lengthwise part 1230′ in a spiral direction.

For example, in the event of a fire, the fire extinguishing agent may be supplied to the internal passage 1122′ by the gas supply unit 3000 through the connection unit 2200′ under control of the controller 300, or the opening/closing part 1400 positioned at the upper end may be opened. That is, the opening/closing part 1400 may be opened based on an operation control signal from the controller 300, and the spray unit 1200′ may be exposed to the outside through the upper end opened by the internal pressure to discharge the fire extinguishing agent in all directions through the plurality of perforations or the edge portion 1231′ to suppress fire. Leaving the spray unit 1200′ exposed to the outside even after the operation for fire suppression is completed (for example, the fire extinguishing agent is completely discharged) may cause interference with a user who is walking around, resulting in injury or a risk of causing injury to the user. In addition, an external shock may act on the spray unit 1200′ exposed to the outside, causing the spray unit 1200′ to be bent or damaged, which may reduce the durability of the apparatus.

Accordingly, the spring 1240′ may have a coil shape, and one end and the opposite end thereof end may be disposed between the head 1220′ and a first surface 1310′ of the bearing 1300′, respectively, such that restoring force to move the spray unit 1200′ back into the body 1100′ may be applied. That is, when the pressure acting on the internal passage 1111′ and the spray unit 1200′ decreases over time due to the continuous discharge of the fire extinguishing agent, the spray unit 1200′ may be moved into the internal passage 1111′, that is, the body 1100′ by the restoring force generated through the spring 1240′ disposed between the head 1220′ and the first surface 1310′ of the bearing 1300′. Therefore, injury to users or damage to the apparatus that may occur after extinguishing a fire may be prevented.

According to an embodiment of the present disclosure, the spray unit 1200′ may include a dust film 1250 to block the supply of the fire extinguishing agent discharged from the lengthwise part 1230′ to the internal passage 1122′. Specifically, the spray unit 1200′ may include a dust film 1250 having one end connected to one surface of the head and the opposite end connected to one surface of the bearing. The dust film may have a cylindrical bellows structure. For example, the dust film 1250 may be provided in a cylindrical bellows structure surrounding the outer circumferential surface of the lengthwise part 1230′ as shown in FIG. 14-(b). In this case, the dust film 1250 may be provided to block the supply of the fire extinguishing agent discharged from the lengthwise part 1230′ to the internal passage 1122′. For example, the dust film 1250 may be formed of a thin vinyl film and have a bellows structure to minimize the volume thereof in response to a force acting in a direction of the lengthwise part 1230′ (i.e., a vertical direction).

Accordingly, the fire extinguishing agent discharged into the internal passage 1111′ may be blocked, and when the spray unit 1200′ is discharged to the outside for fire suppression, the dust film may be arranged to minimize the volume between the first surface 1310′ of the bearing 1300′ and the head 1220′. In this case, the dust film 1250 may buffer an impact generated when the bearing 1300′ and the head 1220′ come into contact with each other.

For example, when the opening/closing part 1400 is opened and the fire extinguishing agent is passed through the connection unit 2200′ and supplied into the internal passage 1111′ of the body 1100′, the spray unit 1200′ may be raised and exposed to the outside of the open apparatus according to the increase in the internal pressure. The spray unit 1200′ exposed to the outside may discharge the fire extinguishing agent in all directions through the center hole 1210′ and the plurality of perforations 1232, thereby suppressing a fire corresponding to a specific area (e.g., an area where the spray unit is provided). However, even when the spray unit 1200′ is positioned in the internal passage 1111′, the fire extinguishing agent may be discharged into the internal passage 1111′ through the center hole 1210′ and the plurality of perforations 1232 of the spray unit 1200′. That is, during continuous use of the fire extinguishing unit 100, dust or powder related to the fire extinguishing agent may be accumulated in the internal passage 1111′, which may reduce the operating efficiency of the apparatus. For example, there is a concern that the corrosion of the internal passage 1111′ is accelerated by the fire extinguishing agent, or the vertical movement of the spray unit 1200′ may not be smooth due to the accumulation of powder related to the fire extinguishing agent.

Accordingly, the dust film 1250 may be disposed between the head 1220′ and the first surface 1310′ of the bearing 1300′ in the cylindrical bellows structure to block the fire extinguishing agent discharged from the lengthwise part 1230′ from being supplied into the internal passage 1111′. That is, by providing the dust film 1250 disposed to surround the spray unit 1200′ in the internal passage 1111′, damages such as corrosion or wear by the fire extinguishing agent that may occur inside the apparatus during the continuous use of the apparatus may be prevented.

According to an embodiment of the present disclosure, the valve structure 1000′ may include a bearing 1300′ configured to control the movement of the spray unit 1200′. In addition, the bearing 1300′ may include a first surface 1310′ being in contact with the head 1220′ and a second surface 1320′ opposite the first surface 1310′. That is, the first surface 1310′ may represent one surface of the bearing 1300′ that contacts the head 1220′, and the second surface 1320′ may represent another surface of the bearing 1300′ positioned on the side of the opening/closing part 1400.

As shown in FIGS. 13 and 14, the bearing 1300′ may be arranged between the first body 1110′ and the second body 1120′, and may be supported by the inner support step 1122b protruding from the second body 1120′ toward the center. The bearing 1300′ may also include a through-hole 1300a having an inner diameter corresponding to the diameter of the lengthwise part 1230′ and penetrated by the lengthwise part 1230′. For example, when the diameter of the lengthwise part 1230′ is 1 cm, the inner diameter of the through-hole 1300a penetrated by the lengthwise part 1230′ may be 1.1 cm. That is, the lengthwise part 1230′ may be exposed to the outside by passing through the bearing 1300′ supported by the inner support step 1122b formed in the internal passage 1111′ as it is formed to have a smaller diameter than the through-hole 1300a. That is, the head 1220′ of the spray unit 1200′ may be supported on the first surface 1310′ of the bearing 1300′, and only the lengthwise part 1230′ may be exposed to the outside through the through-hole 1300a.

For example, there may be difficulties in structural design, that is, injection molding for forming a hole (i.e., through-hole) and a prevention surface (i.e., the first surface) for the bearing 1300′ inside the internal passage 1111′. The bearing 1300′ of the present disclosure may be manufactured through a relatively simple process through formation including a hole in the center, and may be disposed inside the body 1100′ (that is, supported on the inner support step). As a result, convenience may be improved in the manufacturing or injection molding process.

According to an embodiment, the first surface 1310′ may include a shock prevention part 1311′ for absorbing shock caused by contact with the head 1220′. Specifically, when a fire occurs, the fire extinguishing agent may be supplied into the internal passage 1111′ of the body 1100′ through the connection unit 2200′, and the opening/closing part 1400 may be opened according to the increase in internal pressure, and the spray unit 1200′ may be raised and exposed to the outside as shown in FIG. 13-(b). In this case, the bearing 1300′ may be supported by the inner support step 1122b of the second body 1120′, and the spray unit 1200′ may be prevented from being completely separated from the fire extinguishing unit 100. Also, the bearing 1300′ may include a through-hole 1300a having a diameter larger than the outer diameter of the lengthwise part 1230′ but smaller than the head diameter 1220a of the head 1220′.

Accordingly, when the spray unit 1200 is raised by the pressure, the first surface 1310′ of the bearing 1300′ comes into contact with one surface of the head 1220′ to prevent the spray unit 1200′ from being separated off. Here, since the exposure of the spray unit 1200′ (i.e., the spray mechanism) is achieved through an increase in pressure, shock generated during the contact between the head 1220′ and the first surface 1310′ of the bearing 1300′ may cause damage to the apparatus.

Accordingly, as shown in FIG. 14, when the spray unit 1200′ is exposed to the outside by the pressure (i.e., the spray unit is raised by the pressure), a shock prevention part 1311′ formed of a shock absorbing material may be provided on the first surface 1310′ of the bearing 1300′ in contact with the head 1220′. Thereby, the shock caused by the contact between the bearing 1300′ and the head 1220′ during the operation of the spray mechanism for fire suppression may be minimized, and the stability of the apparatus may be secured. That is, damage to the spray unit 1200′ or the bearing 1300′ may be prevented by the shock prevention part 1311′, and accordingly the operating efficiency of the apparatus may be improved.

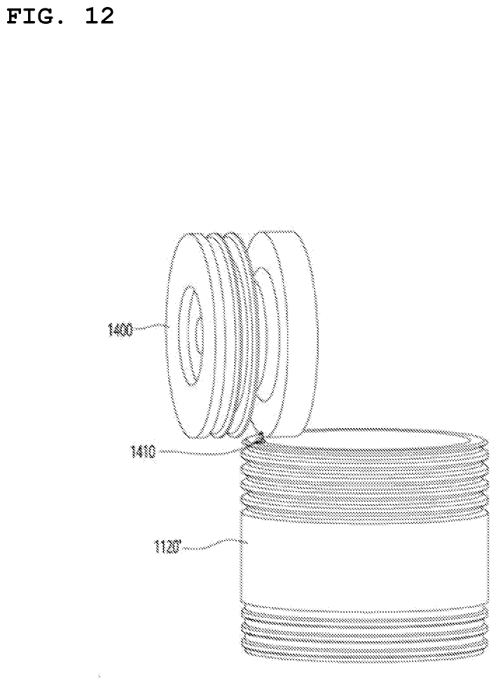

According to an embodiment of the present disclosure, the valve structure 1000′ may include an opening/closing part 1400 configured to open and close an upper end of the body 1100′. The opening/closing part 1400 may be connected to a portion of the top surface of the body 1400 to be opened or closed. The opening/closing part 1400 may include a second coupling portion 1410 for coupling with the body 1100′. Specifically, as shown in FIG. 12, the second coupling portion 1410 may form a coupling mechanism with one surface of the second body 1120′ to connect the opening/closing part 1400 to the one surface of the second body 1120′. For example, the coupling mechanism that may be formed between the opening/closing part 1400 and the second body 1120′ may include various coupling methods such as clip coupling, magnet coupling, band coupling, hinge coupling, or suction coupling. The specific description of the coupling mechanism given above is merely an example, and the present disclosure is not limited thereto. The opening/closing part 1400 may be opened by the movement of the spray unit 1200′ according to the pressure applied to the inside of the body 1100′. According to an embodiment, the opening/closing part 1400 may open the top surface of the body 1100′ based on an operation control signal from the controller 300. For example, when the opening/closing part 1400 is opened, the pressure according to the supply of the fire extinguishing agent may act on the internal passage 1111′ and the spray unit 1200′, and thus the spray unit 1200 may be exposed to the outside of the apparatus.

In an additional embodiment, the opening/closing part 1400 may be opened to the side opposite to the side on which the spray unit 1200′ is exposed. In this case, the opening/closing part 1400 may include one or more support members, and may be supported on the upper side of the spray unit 1200′ exposed to the outside by the one or more support members. The one or more support members have a predetermined height (e.g., a height corresponding to the lengthwise part). In addition, the support members may be arranged at equal intervals. The one or more support members may be accommodated inside the body 1100′ in a closed state and may open the valve structure 1000′ by raising the opening/closing part 1400 according to the rise of the spray unit 1200′. That is, when the spray unit 1200′ is raised and exposed to the outside, the opening/closing part 1400 may be disposed above the spray unit 1200′ through the one or more support members.

For example, the spray unit 1200′ includes the sharp edge portion 1231′. Accordingly, when the spray unit 1200′ is exposed to the outside, there is a risk of injury to a user. In addition, an external shock may act on the spray unit 1200′ exposed to the outside, causing bending or damage to the spray unit 1200′, which may reduce the durability of the apparatus. As described above, when the spray unit 1200′ is exposed to the outside to perform spraying, the opening/closing part 1400 may be disposed above the spray unit 1200′ through the one or more support members. Therefore, the spray unit 1200′ may be prevented from causing an injury to a user. In addition, the spray unit 1200′ exposed to the outside may be protected so as not to cause damage.

Although the embodiments of the present disclosure have been described with reference to the accompanying drawings, those skilled in the art to which the present invention belongs will appreciate that various modifications can be made to the present invention without departing from the technical spirit or essential features of the present disclosure. Therefore, it should be understood that the embodiments described above are illustrative in all respects and not restrictive.

Specific implementations described in the present disclosure are examples and are not intended to limit the scope of the disclosure in any way. For simplicity, description of conventional electronic components, control systems, software, and other functional aspects of the systems may be omitted. In addition, the connection of lines or connecting members between the components shown in the drawings represent functional connections and/or physical or circuit connections by way of example. In actual devices, various replaceable or additional functional connections, physical connections, or circuit connections may be provided. In addition, if there is no specific reference such as “essential” or “important”, the corresponding component may not be a necessary component for the application of the present disclosure.

It is to be understood that the specific order or hierarchy of steps in the processes presented is an example of illustrative approaches. Based upon design priorities, it is to be understood that the specific order or hierarchy of steps in the processes may be rearranged within the scope of this disclosure. The accompanying method claims present elements of the various steps in a sample order, but are not meant to be limited to the specific order or hierarchy presented.

The description of the presented embodiments is provided to enable any person skilled in the art to use or practice the present disclosure.

Various modifications to these embodiments will be apparent to those skilled in the art of this disclosure, and the general principles defined herein may be applied to other embodiments without departing from the scope of this disclosure. Thus, the present disclosure is not to be limited to the embodiments presented herein, but is to be interpreted in the widest scope consistent with the principles and novel features presented herein.

### LIST OF REFERENCE NUMERALS

| | |
|---|---|
| 10: Fire Suppression System | 100: Fire Extinguishing Unit |
| 1000: Valve Structure | 1100: Body |
| 1110: First Body | 1111: Internal Passage |
| 1112: Outer Rotation Groove | 1113: Inwardly protruding step |
| 1114: LowerPassage | 1115: First Support Surface |
| 1116: Second Support Surface | 1117: Control Valve Fixing Part |
| 1120: Second Body | 1121: Discharge Hole |
| 1122: Spray Unit Support Surface | 1123: Inner Rotation Groove |
| 1200: Spray Unit | 1210: Head |
| 1220: Lengthwise Part | 1221: Plurality Of Perforations |
| 1230: Center Hole | 1231: Spray Protrusion Support Surface |
| 1240: Spray Protrusion | 1241: Spray Protrusion Support Step |
| 1242: Spray Surface | 1300: Control Valve |
| 1310: Control Valve Head | 1311: Spring Support Surface |
| 1320: Control Valve Lengthwise Part | 1321: Packing Member |
| 1322: Packing Groove | 1323: Control Valve Center Hole |
| 1324: Plurality of Agent Discharge Holes | 1330: Spring |
| 1000′: Valve Structure | 1001: First Valve Structure |
| 1002: Second Valve Structure | 1100′: Body |
| 1110′: First Body | 1111′: Internal Passage |
| 1111a: Internal Passage Diameter | 1112′: First Coupling Portion |
| 1112a: Inner Rotation Groove | 1120′: Second Body |
| 1121a: Outer Rotation Groove | 1122′: Internal Passage |
| 1122a: Internal Passage Diameter | 1122b: Inner Support Step |
| 1200′: Spray Unit | 1210′: Center Hole |
| 1210a: Center Hole Diameter | 1220′: Head |
| 1220a: Head Diameter: | 1222: Shock Absorber |
| 1223: Movement Guide Part | 1230′: Lengthwise Part |
| 1231′: Edge Portion | 1232: Plurality Of Perforations |
| 1240′: Spring | 1250: Dust Film |
| 1300′: Bearing | 1300a: Through-Hole |
| 1310′: First Surface | 1311′: Shock Prevention Part |
| 1320′: Second Surface | 1400: Opening/Closing Part |
| 1410: Second Coupling Portion | 2000: Fire Extinguishing Cylinder |
| 2100: Inner Space | 2200: Connection Unit |
| 2210: Shut-Off Valve | 2220: Lower Connection Groove |
| 2300: Lower Space | 2320: Lower Coupling Portion |
| 3000: Gas Supply Unit | 3100: Supply Unit |
| 3110: Shaft | 3120: Passage |
| 3130: Outlet | 3200: Storage Unit |
| 3300: Coupling Portion | 200: Sensor Unit |
| 300: Controller | |

1. A valve structure comprising:
a body defining an internal passage and including a discharge hole with a predetermined diameter on one end of the internal passage; and
a spray unit that is configured to be received in the internal passage and is movable along the internal passage to project through the discharge hole to an outside of the body,
wherein the spray unit comprises:
a head having a diameter corresponding to an inner diameter of the internal passage and configured to move vertically in response to a pressure applied to the internal passage;
a lengthwise part extending in one direction from the head and having a plurality of perforations;
a center hole longitudinally formed through the head and the lengthwise part and connected to the plurality of perforations wherein the center hole extends from the head to one end of the lengthwise part that is opposite the head; and
a spray protrusion provided at the one end of the lengthwise part,
wherein at least a portion of the lengthwise part is constructed to project to the outside of the body when the pressure is applied to the internal passage and then to the center hole,
wherein the spray protrusion is configured to extend from the lengthwise part to open the center hole at the one end of the lengthwise part.

2. The valve structure of claim 1, wherein the spray protrusion extends from the lengthwise part when the pressure is applied to the center hole.

3. The valve structure of claim 1, wherein the body comprises:
an inwardly protruding step; and
a lower passage provided below the inwardly protruding step.

4. The valve structure of claim 1, wherein the spray protrusion comprises:
a spray protrusion support step located inside the center hole at the one end of the lengthwise part and vertically movable until being resisted by a protrusion support surface on the lengthwise part; and
a spray surface located outside the one end of the lengthwise part and formed in a step shape extending along an outer circumferential surface of the lengthwise part.

5. The valve structure of claim 3, further comprising:
a control valve provided in the lower passage and constructed to be at least partially moved into the internal passage, the control valve being configured to control introduction of a fire extinguishing agent into the internal passage.

6. The valve structure of claim 5, wherein the control valve comprises:
a control valve head configured to perform a vertical movement in response to a pressure applied thereto;
a control valve lengthwise part extending from the control valve head in one direction and having a plurality of agent discharge holes;
a control valve center hole longitudinally formed inside the control valve head and the control valve lengthwise part and connected to the plurality of agent discharge holes; and
a spring, one end of which is connected to one surface of the control valve head and another end of which is connected to an inner portion of the body to control a vertical movement of the control valve head.

7. A fire suppression system, comprising:
a fire extinguishing unit, having a valve structure and configured to discharge a fire extinguishing agent to suppress fire;
a sensor unit configured to sense environmental information; and
a controller configured to control an operation of the fire extinguishing unit based on the environment information,
wherein the valve structure comprises:
a body defining an internal passage and including a discharge hole with a predetermined diameter on one end of the internal passage; and
a spray unit that is configured to be received in the internal passage and is movable along the internal passage to project to an outside of the discharge hole
wherein the spray unit comprises:
a head having a diameter corresponding to an inner diameter of the internal passage and configured to move vertically in response to a pressure applied to the internal passage;
a lengthwise part extending in one direction from the head and having a plurality of perforations;
a center hole longitudinally formed through the head and the lengthwise part and connected to the plurality of perforations wherein the center hole extends from the head to one end of the lengthwise part that is opposite the head; and
a spray protrusion provided at the one end of the lengthwise part,
wherein at least a portion of the lengthwise part is constructed to project to the outside of the body when the pressure is applied to the internal passage and then to the center hole,
wherein the spray protrusion is configured to extend from the lengthwise part to open the center hole at the one end of the lengthwise part,
wherein the spray protrusion extends from the lengthwise part when the pressure is applied to the center hole.

8. The fire suppression system of claim 7, wherein the spray protrusion comprises:
a spray protrusion support step located inside the center hole at the one end of the lengthwise part and vertically movable until being resisted by a protrusion support surface on the lengthwise part; and
a spray surface located outside the one end of the lengthwise part and formed in a step shape extending along an outer circumferential surface of the lengthwise part.

9. The fire suppression system of claim 7, wherein the body comprises an inwardly protruding step and a lower passage provided below the inwardly protruding step,
wherein the valve structure further comprises a control valve provided in the lower passage and constructed to be at least partially moved into the internal passage, the control valve being configured to control introduction of a fire extinguishing agent into the internal passage,
wherein the control valve comprises:
a control valve head configured to perform a vertical movement in response to a pressure applied thereto;
a control valve lengthwise part extending from the control valve head in one direction and having a plurality of agent discharge holes;
a control valve center hole longitudinally formed inside the control valve head and the control valve lengthwise part and connected to the plurality of agent discharge holes; and
a spring, one end of which is connected to one surface of the control valve head and another end of which is connected to an inner portion of the body to control a vertical movement of the control valve head.

10. The fire suppression system of claim 7, wherein the fire extinguishing unit further comprises:
a fire extinguishing cylinder configured to deliver the fire extinguishing agent to the valve structure; and
a gas supply unit containing the fire extinguishing agent therein and configured to supply the fire extinguishing agent to the fire extinguishing cylinder.

11. The fire suppression system of claim 10, further comprises a connection unit having a shut-off valve to allow delivery of the fire extinguishing agent from the gas supply unit, through the shut-off valve to the fire extinguishing cylinder, to the lower passage, and then to the internal passage.

12. A valve structure for controlling a discharge of a fire extinguishing agent to suppress fire, comprising:
a body defining an internal passage and including a discharge hole with a predetermined diameter on one end of the internal passage; and
a spray unit that is configured to be received in the internal passage and is movable along the internal passage to project through the discharge hole to an outside of the body,
wherein the spray unit comprises:
a head having a diameter corresponding to an inner diameter of the internal passage that is smaller than the predetermined diameter;
a lengthwise part extending from the head and having a plurality of perforations to discharge the fire extinguishing agent;
a center hole longitudinally formed inside and through the head and the lengthwise part and connected to the plurality of perforations; and
a spray protrusion provided at one end of the lengthwise part,
wherein at least a portion of the lengthwise part is constructed to project to the outside of the body when a pressure is applied to the internal passage and then to the center hole,
wherein the spray protrusion is configured to extend from the lengthwise part to open the center hole at the one end of the lengthwise part when the pressure is applied to the center hole.

13. The valve structure of claim 12, wherein the spray protrusion comprises:
a spray protrusion support step located inside the center hole at the one end of the lengthwise part and vertically movable until being resisted by a protrusion support surface on the lengthwise part; and
a spray surface located outside the one end of the lengthwise part and formed in a step shape extending along an outer circumferential surface of the lengthwise part,
wherein the pressure applied to the center hole pushes the spray protrusion support step until the spray protrusion support step comes into contact with the protrusion support surface of the lengthwise part, thereby opening the center hole to discharge fire extinguishing agent that hits the spray surface to disperse in multiple directions.

14. The valve structure of claim 12, wherein the body comprises a first body and a second body, wherein the discharge hole is formed on the second body and the first body and the second body are removably coupled to each other, and
wherein removing the second body from the first body enables the spray unit to be removed from the internal passage of the first body.

15. The valve structure of claim 12, wherein the body further comprises an inwardly protruding step and a lower passage provided below the inwardly protruding step,
wherein the valve structure further comprises a control valve provided in the lower passage and constructed to be at least partially moved into the internal passage, the control valve being configured to control introduction of the fire extinguishing agent into the internal passage.

16. The valve structure of claim 15, wherein the control valve comprises:
a control valve head configured to perform a vertical movement in response to a pressure applied to the control valve;
a control valve lengthwise part extending from the control valve head and having a plurality of agent discharge holes;
a control valve center hole longitudinally formed inside the control valve head and the control valve lengthwise part and connected to the plurality of agent discharge holes; and
a spring, one end of which is connected to one surface of the control valve head and another end of which is connected to an inwardly protruding step, controlling a vertical movement of the control valve,
wherein the pressure applied to the control valve vertically moves the control valve so that the plurality of agent discharge holes are connected to the internal passage.

17. The valve structure of claim 16, wherein the control valve contacts the head of the spray unit when the pressure is not applied such that the pressure applied to the control valve vertically moves the control valve which in turn vertically moves the head of the spray unit.

18. The valve structure of claim 16, wherein the control valve further comprises a packing member that is located in the internal passage to block a leakage of the fire extinguishing agent from the lower passage to the internal passage when the pressure is not applied.

19. The valve structure of claim 16, wherein the control valve lengthwise part is constructed to fit in the inwardly protruding step.

20. The valve structure of claim 16, further comprising a control valve fixing part which is located at a lower end of the lower passage and inwardly extends, and wherein the control valve fixing part supports the control valve head and is constructed not to allow the control valve head vertically move out of the lower passage.
